(19) United States
(12) Patent Application Publication
(10) Pub. No.: US 2026/0099113 A1
(43) Pub. Date: Apr. 9, 2026

(54) ELECTROPHOTOGRAPHIC APPARATUS AND PROCESS CARTRIDGE

(71) Applicant: CANON KABUSHIKI KAISHA, Tokyo (JP)

(72) Inventors: AKIHIRO MARUYAMA, Shizuoka (JP); FUMIYUKI HIYAMA, Shizuoka (JP); CHIHARU AKIYAMA, Shizuoka (JP); TSUTOMU NISHIDA, Shizuoka (JP)

(21) Appl. No.: 19/345,614

(22) Filed: Sep. 30, 2025

(30) Foreign Application Priority Data
Oct. 8, 2024 (JP) 2024-176792

(51) Int. Cl. G03G 15/08; G03G 5/047; G03G 5/05; G03G 5/06; G03G 21/18

(52) U.S. Cl. CPC G03G 15/0808; G03G 5/047; G03G 5/056; G03G 5/0696; G03G 21/1814

(57) ABSTRACT

An electrophotographic apparatus includes an electrophotographic photosensitive member and a contact developing device configured to develop an electrostatic latent image formed on a surface of the electrophotographic photosensitive member by bringing a developing roller carrying a toner into contact with the electrophotographic photosensitive member. The electrophotographic photosensitive member includes a surface layer containing a binder resin, the binder resin includes a polyester resin, the polyester resin has a structural unit represented by Formula (1) and a structural unit represented by Formula (2), the developing roller has an elastic layer, and the elastic layer contains urethane rubber.

### BACKGROUND

### Field of the Technology

The present disclosure relates to an electrophotographic apparatus and a process cartridge, which include an electrophotographic photosensitive member and a developing roller.

### Description of the Related Art

In recent years, there has been a demand for an electrophotographic apparatus having a longer lifetime and a higher image quality, and it is desirable to provide an apparatus that can output an image with a highly stable image quality even after repeated use (after endurance).

An organic electrophotographic photosensitive member containing an organic photoconductive material (charge generating material) (hereinafter, also simply referred to as “electrophotographic photosensitive member” or “photosensitive member”) has been used as an electrophotographic photosensitive member to be mounted on an electrophotographic apparatus or a process cartridge. In recent years, an electrophotographic apparatus has been required to increase the image quality by suppressing image failure and to maintain a high image quality from an initial stage through to the end of endurance even after repeated use (after endurance) in a high-temperature and high-humidity environment in addition to dealing with the demand for a longer lifetime described above.

Meanwhile, a developing roller having an elastic layer that contains urethane rubber is used in some cases for the purposes of maintaining a high image quality from the initial stage through to the end of endurance and reducing the cost. However, it is found that urethane rubber deteriorates due to hydrolysis when exposed to a high-temperature and high-humidity environment for a long time, and the deterioration of urethane rubber may cause image failure (uneven density) (see Japanese Patent Laid-Open Nos. H10-48942 and 2016-99516).

Japanese Patent Laid-Open No. 2019-74717 describes a developing roller containing urethane rubber obtained by reacting a polyol with a polyisocyanate. Further, Japanese Patent Laid-Open No. 2016-99516 describes a developing roller containing ether-based urethane rubber.

According to the examination conducted by the present inventors, the image quality is degraded after endurance when an electrophotographic apparatus (electrophotographic image forming apparatus) including the developing roller described in Japanese Patent Laid-Open No. H10-48942 or Japanese Patent Laid-Open No. 2019-74717 is used, and thus there is room for improvement.

### SUMMARY

The present disclosure provides an electrophotographic apparatus including a developing roller that has an elastic layer containing urethane rubber, in which image failure (uneven density) after endurance in a high-temperature and high-humidity environment is suppressed and a high image quality is maintained from the initial stage through to the end of endurance.

According to an aspect of the present disclosure, there is provided an electrophotographic apparatus including: an electrophotographic photosensitive member; and a contact developing device having a toner and a developing roller and configured to develop an electrostatic latent image formed on a surface of the electrophotographic photosensitive member by bringing the developing roller carrying the toner into contact with the electrophotographic photosensitive member, in which the electrophotographic photosensitive member includes a surface layer containing a binder resin, the binder resin includes a polyester resin, the polyester resin has a structural unit represented by Formula (1) and a structural unit represented by Formula (2), the developing roller has an elastic layer, and the elastic layer contains urethane rubber.

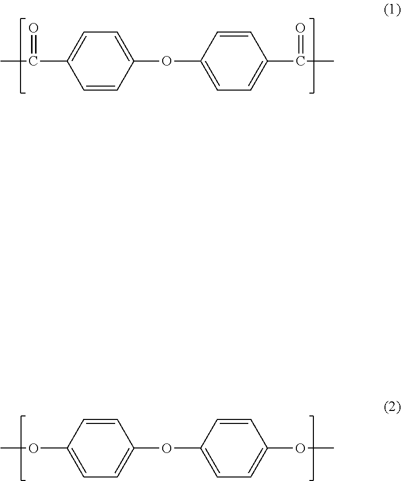

Further, according to another aspect of the present disclosure, there is provided a process cartridge including: an electrophotographic photosensitive member; and a contact developing device having a toner and a developing roller and configured to develop an electrostatic latent image formed on a surface of the electrophotographic photosensitive member by bringing the developing roller carrying the toner into contact with the electrophotographic photosensitive member, in which the process cartridge integrally supports the electrophotographic photosensitive member and the contact developing device, and is detachably attachable to an electrophotographic apparatus main body, in which the electrophotographic photosensitive member includes a surface layer containing a binder resin, the binder resin includes a polyester resin, the polyester resin has a structural unit represented by Formula (1) and a structural unit represented by Formula (2), the developing roller has an elastic layer, and the elastic layer contains urethane rubber.

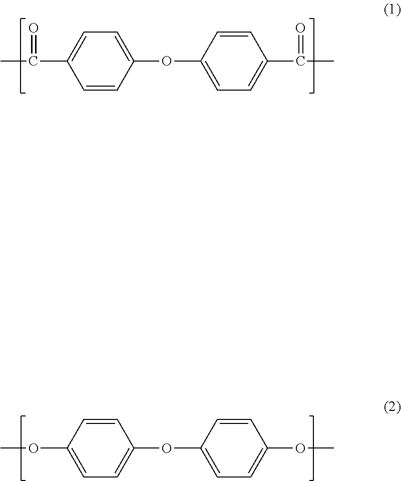

Features of the present disclosure will become apparent from the following description of embodiments with reference to the attached drawings. The following description of embodiments is described by way of example.

### BRIEF DESCRIPTION OF THE DRAWINGS

FIG. 1 is a view showing an example of a layer configuration of an electrophotographic photosensitive member according to the present disclosure.

FIG. 2 is a view showing an example of the layer configuration of the electrophotographic photosensitive member according to the present disclosure.

FIG. 3 is a view showing an example of the layer configuration of the electrophotographic photosensitive member according to the present disclosure.

FIG. 4 is a view showing an example of the layer configuration of the electrophotographic photosensitive member according to the present disclosure.

FIG. 5 is a view showing an example of the layer configuration of the electrophotographic photosensitive member according to the present disclosure.

FIG. 6 is a view showing an example of the layer configuration of the electrophotographic photosensitive member according to the present disclosure.

FIG. 7 is a view showing an example of a configuration of a developing roller according to the present disclosure.

FIG. 8 is a view showing an example of a schematic configuration of an electrophotographic apparatus including the electrophotographic photosensitive member according to the present disclosure.

### DESCRIPTION OF THE EMBODIMENTS

Hereinafter, the technique of the present disclosure will be described in detail with reference to suitable embodiments.

In an image forming apparatus including a developing roller that has an elastic layer containing urethane rubber described in Japanese Patent Laid-Open No. H10-48942 or 2019-74717, it is found that image failure (uneven density) occurs after endurance of the apparatus in a high-temperature and high-humidity environment.

For this reason, even in a case of the developing roller that has an elastic layer containing urethane rubber for the purpose of suppressing deterioration of urethane rubber, it is considered that the urethane rubber of the developing roller that has an elastic layer containing the urethane rubber is hydrolyzed after long-term endurance in a high-temperature and high-humidity environment. Further, the hardness of the elastic layer is considered to become non-uniform at a microscopic level. Therefore, it is assumed that unevenness in pressing pressure occurs during development of a toner on an electrophotographic photosensitive member, a portion where the amount of the toner is different from a desired amount of the toner is generated on the electrophotographic photosensitive member, and as a result, image failure (uneven density) occurs.

Based on the assumption described above, as a result of various examinations on a method for an electrophotographic apparatus including a developing roller that has an elastic layer containing urethane rubber, in which image failure (uneven density) after endurance in a high-temperature and high-humidity environment is suppressed and a high image quality is maintained from an initial stage through to the end of endurance, the configuration of the present disclosure has been completed.

An electrophotographic apparatus according to the present disclosure is an electrophotographic apparatus including an electrophotographic photosensitive member, and a contact developing device having a toner and a developing roller and configured to develop an electrostatic latent image formed on a surface of the electrophotographic photosensitive member by bringing the developing roller carrying the toner into contact with the electrophotographic photosensitive member, in which the electrophotographic photosensitive member includes a surface layer containing a binder resin, the binder resin includes a polyester resin, the polyester resin has a structural unit represented by Formula (1) and a structural unit represented by Formula (2), the developing roller has an elastic layer, and the elastic layer contains urethane rubber.

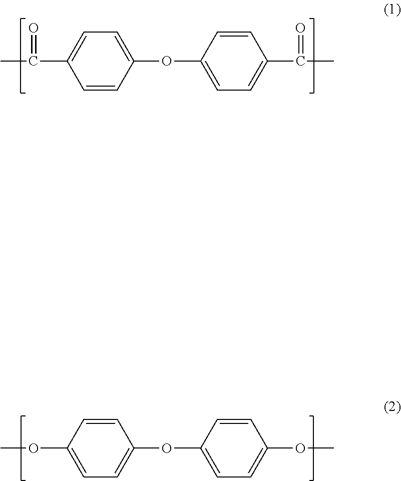

In the present disclosure, the developing roller includes a shaft member and an elastic layer provided on an outer periphery of the shaft member, and the elastic layer contains urethane rubber.

Further, the electrophotographic photosensitive member includes a surface layer containing a binder resin, and the binder resin includes a polyester resin having a structural unit represented by Formula (1) and a structural unit represented by Formula (2). It is found that with this configuration, image failure (uneven density) after endurance in a high-temperature and high-humidity environment is suppressed, and a high image quality can be maintained from the initial stage through to the end of endurance.

It is speculated that since the polyester resin having a structural unit represented by Formula (1) and a structural unit represented by Formula (2) has an ether structure, the degree of freedom is imparted to the resin structure, and a uniform film is easily formed. It is considered that the electrophotographic photosensitive member containing the resin is in the form of a more uniform film, and thus the pressing pressure during the development of the toner from the developing roller is more uniformly transmitted. The urethane rubber in the developing roller and the elastic layer is considered to be hydrolyzed when exposed to a high-temperature and high-humidity environment for a long period of time. The hydrolysis causes microscopic local failure of the urethane rubber, which is considered to lead a non-uniform pressing pressure of the toner during the development of the toner from the developing roller on the surface of the electrophotographic photosensitive member. It is considered that since the electrophotographic photosensitive member contains the resin, the unevenness in the pressing pressure of the developing roller is relatively leveled out by the electrophotographic photosensitive member, and thus the image failure after endurance in a high-temperature and high-humidity environment is reduced.

### Electrophotographic Photosensitive Member

An electrophotographic photosensitive member usually includes a support and a photosensitive layer formed on the support. Examples of the electrophotographic photosensitive member include a single-layer electrophotographic photosensitive member (single-layer photosensitive member) including a single-layer photosensitive layer, a negatively charged laminated-type electrophotographic photosensitive member (negatively charged laminated-type photosensitive member) including a laminated-type photosensitive layer, and a positively charged laminated-type electrophotographic photosensitive member (positively charged laminated-type photosensitive member) including a laminated-type photosensitive layer.

Examples of a method of producing the electrophotographic photosensitive member of the present disclosure include a method of preparing a coating liquid for each layer described below, coating the layer with the coating liquid in order from the more desired layer, and drying the coating liquid. Here, examples of a coating method for the coating liquid include dip coating, spray coating, ink jet coating, roll coating, die coating, blade coating, curtain coating, wire bar coating, and ring coating. Among these, dip coating can be used from the viewpoints of efficiency and productivity.

Hereinafter, the details will be described.

### Single-Layer Photosensitive Member

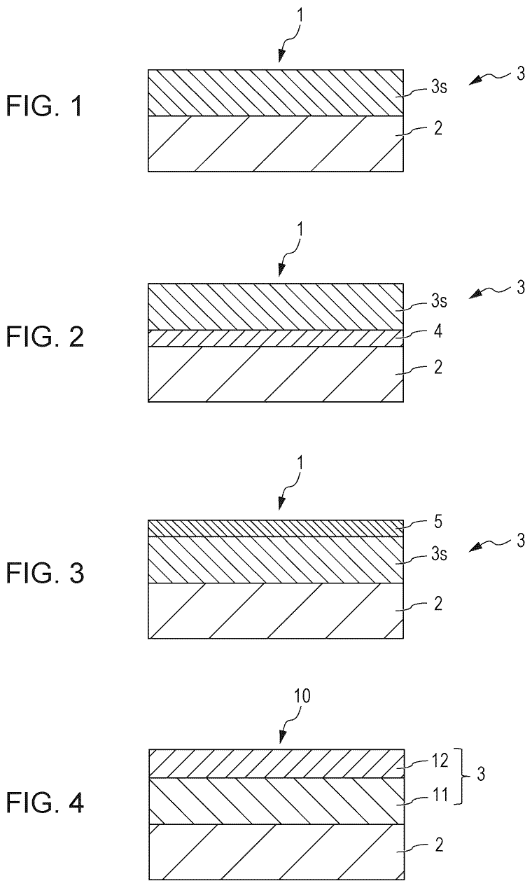

Hereinafter, a single-layer photosensitive member will be described as an example of the photosensitive member with reference to FIGS. 1 to 3. FIGS. 1 to 3 each show a partial cross-sectional view of a single-layer photosensitive member. As shown in FIG. 1, a single-layer photosensitive member 1 includes, for example, a support 2 and a photosensitive layer 3. The photosensitive layer 3 of the single-layer photosensitive member 1 is a single-layer photosensitive layer 3s configured as a single layer (one layer). As shown in FIG. 2, the single-layer photosensitive member 1 may further include an undercoat layer 4 (intermediate layer) in addition to the support 2 and the single-layer photosensitive layer 3s. The undercoat layer 4 is provided between the support 2 and the single-layer photosensitive layer 3s. As shown in FIG. 1, the single-layer photosensitive layer 3s may be provided directly on the support 2. As shown in FIG. 2, the single-layer photosensitive layer 3s may be provided on the support 2 via the undercoat layer 4. As shown in FIG. 3, the single-layer photosensitive member 1 may further include a protective layer 5 in addition to the support 2 and the single-layer photosensitive layer 3s. The protective layer 5 is provided on the single-layer photosensitive layer 3s. As shown in FIGS. 1 and 2, the single-layer photosensitive layer 3s can be provided as a surface layer of the single-layer photosensitive member 1. A decrease in transfer efficiency after endurance is likely to be suppressed by providing the single-layer photosensitive layer 3s containing a polyester resin (PAR) described below as the surface layer. Further, as shown in FIG. 3, the protective layer 5 may be provided as the surface layer of the single-layer photosensitive member 1. The thickness of the single-layer photosensitive layer 3s is not particularly limited, but can be set to 5 μm or greater and 100 μm or less, or 10 μm or greater and 50 μm or less. The single-layer photosensitive layer 3s contains a charge generating material, a binder resin, an electron transporting material, and a hole transporting material.

### Positively Charged Laminated-Type Photosensitive Member

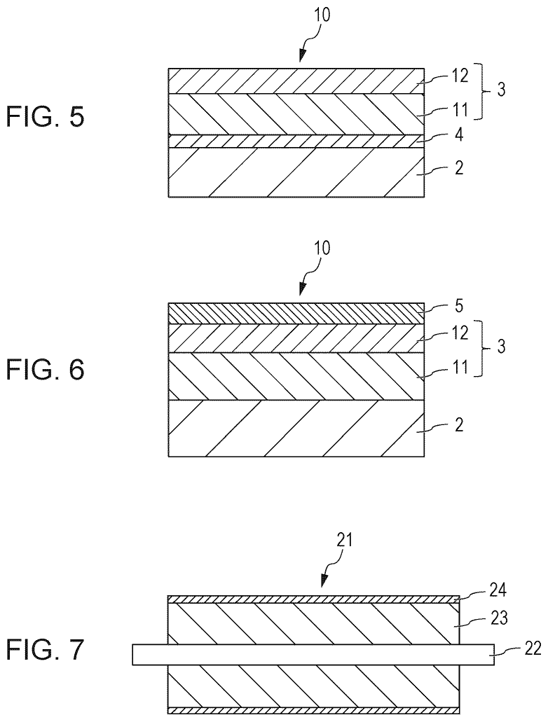

Hereinafter, a positively charged laminated-type photosensitive member 10 will be described as another example of the photosensitive member with reference to FIGS. 4 to 6. FIGS. 4 to 6 each show a partial cross-sectional view of the positively charged laminated-type photosensitive member 10. As shown in FIG. 4, the positively charged laminated-type photosensitive member 10 includes, for example, the support 2 and the photosensitive layer 3. The photosensitive layer 3 of the positively charged laminated-type photosensitive member 10 is formed of a plurality of layers (two or more layers) and includes a charge generating layer 12 and a charge transporting layer 11. Between the charge generating layer 12 and the charge transporting layer 11, the charge generating layer 12 is provided on a surface side. The charge transporting layer 11 is provided on a side of the support 2 with respect to the charge generating layer 12. Since the charge generating layer 12 is positioned on the surface side (on a side of the positively charged laminated-type photosensitive member 10 opposite to a side where the support 2 is provided), for example, the charge transporting layer 11 is provided on the support 2, and the charge generating layer 12 is provided on the charge transporting layer 11. In a case where the electrophotographic apparatus includes the positively charged laminated-type photosensitive member 10, the positively charged laminated-type photosensitive member 10 is charged to a positive polarity by a charging device. As shown in FIG. 5, the positively charged laminated-type photosensitive member 10 may further include the undercoat layer 4 (intermediate layer) in addition to the support 2 and the photosensitive layer 3. The undercoat layer 4 is provided between the support 2 and the photosensitive layer 3 (for example, the charge transporting layer 11). As shown in FIG. 4, the photosensitive layer 3 (for example, the charge transporting layer 11) may be provided directly on the support 2. Alternatively, as shown in FIG. 5, the photosensitive layer 3 (for example, the charge transporting layer 11) may be provided on the support 2 via the undercoat layer 4. As shown in FIG. 6, the positively charged laminated-type photosensitive member 10 may further include the protective layer 5 in addition to the support 2 and the photosensitive layer 3. The protective layer 5 is provided on the photosensitive layer 3 (for example, the charge generating layer 12). As shown in FIGS. 4 and 5, the photosensitive layer 3 can be provided as the surface layer of the positively charged laminated-type photosensitive member 10. When the photosensitive layer 3 (for example, the charge generating layer 12) containing a polyarylate resin (PA) described below and a specific electron transporting agent described below is provided as the surface layer, the fogging resistance of the positively charged laminated-type photosensitive member 10 is likely to be improved. Further, as shown in FIG. 6, the protective layer 5 may be provided as the surface layer of the positively charged laminated-type photosensitive member 10.

### Support

In the present disclosure, the electrophotographic photosensitive member includes a support. In the present disclosure, the support can be a support having conductivity (conductive support). Further, examples of the shape of the support include a cylindrical shape, a belt shape, and a sheet shape. Among these, a cylindrical support can be used. Further, a surface of the support may be subjected to an electrochemical treatment such as anodization, a blast treatment, a cutting treatment, or the like.

A metal, a resin, glass, or the like can be used as the material of the support.

Examples of the metal include aluminum, iron, nickel, copper, gold, stainless steel, and alloys thereof. Among these, an aluminum support formed of aluminum can be used.

Further, conductivity may be imparted to a resin or glass by mixing a conductive material with the resin or the glass or coating the resin or the glass with a conductive material.

### Undercoat Layer

In the present disclosure, the undercoat layer may be provided on the support. When the undercoat layer is provided, an adhesion function between layers is enhanced, and a charge injection blocking function can be imparted.

The undercoat layer can contain a resin. Further, the undercoat layer may be formed as a cured film by polymerizing a composition that contains a monomer containing a polymerizable functional group.

Examples of the resin include a polyester resin, a polyarylate resin, a polycarbonate resin, a polyvinyl acetal resin, an acrylic resin, an epoxy resin, a melamine resin, a polyurethane resin, a phenol resin, a polyvinylphenol resin, an alkyd resin, a polyvinyl alcohol resin, a polyethylene oxide resin, a polypropylene oxide resin, a polyamide resin, a polyamic acid resin, a polyimide resin, a polyamide-imide resin, and a cellulose resin.

In the monomer containing a polymerizable functional group, examples of the polymerizable functional group include an isocyanate group, a block isocyanate group, a methylol group, an alkylated methylol group, an epoxy group, a metal alkoxide group, a hydroxy group, an amino group, a carboxy group, a thiol group, a carboxylic anhydride group, and a carbon-carbon double bond group.

Further, the undercoat layer may further contain an electron transporting material, a metal oxide, a metal, a conductive polymer, and the like for the purpose of enhancing electrical properties. Among these, an electron transporting material and a metal oxide can be used.

Examples of the electron transporting material include a quinone compound, an imide compound, a benzimidazole compound, a cyclopentadienylidene compound, a fluorenone compound, a xanthone compound, a benzophenone compound, a cyanovinyl compound, an aryl halide compound, a silole compound, and a boron-containing compound. The undercoat layer may be formed as a cured film by using an electron transporting material containing a polymerizable functional group as the electron transporting material and copolymerizing the above-described monomer containing the polymerizable functional group with the electron transporting material.

Examples of the metal oxide include indium tin oxide, tin oxide, indium oxide, titanium oxide, zinc oxide, aluminum oxide, and silicon dioxide. Examples of the metal include gold, silver, and aluminum.

Further, the undercoat layer may further contain an additive.

The average film thickness of the undercoat layer can be set to 0.1 μm or greater and 50 μm or less, 0.2 μm or greater and 40 μm or less, or 0.3 μm or greater and 30 μm or less.

The undercoat layer can be formed by preparing a coating liquid for an undercoat layer, which contains the above-described materials and a solvent, to form a coating film and drying and/or curing the coating film. Examples of the solvent used in the coating liquid include an alcohol-based solvent, a ketone-based solvent, an ether-based solvent, an ester-based solvent, and an aromatic hydrocarbon-based solvent.

### Single-Layer Photosensitive Layer

In the present disclosure, a single-layer photosensitive layer can be provided on the support or the undercoat layer or the like provided on the support.

The single-layer photosensitive layer can contain a binder resin, a charge generating material, a hole transporting material, and an electron transporting material.

### Binder Resin

The binder resin used in the photosensitive layer includes a polyester resin having a structural unit represented by Formula (1) and a structural unit represented by Formula (2).

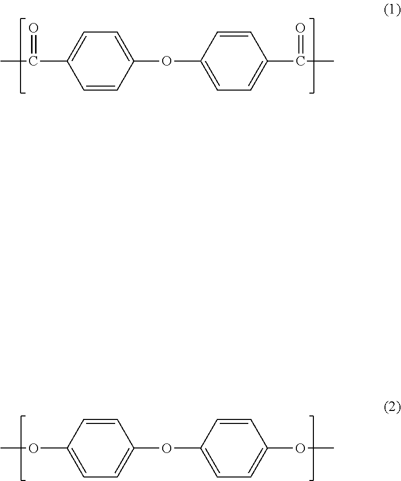

The structural unit represented by Formula (1) is a structure having high electron accepting properties. Further, in a case where the structural unit represented by Formula (1) is bonded to the structural unit represented by Formula (2), the structural unit represented by Formula (1) is resonance-stabilized, and the electron accepting properties are further increased. The electrophotographic photosensitive member that contains a polyester resin having the structural unit represented by Formula (1) and the structural unit represented by Formula (2) is considered to assist the positive chargeability of the toner when the positively charged toner is developed on the electrophotographic photosensitive member and transferred to a transfer member. It is assumed that, with this configuration, the electrophotographic photosensitive member is relatively negatively charged, the positive chargeability of the toner is relatively increased, and the residual transfer toner is reduced.

The polyester resin may further have a structural unit represented by Formula (4) and a structural unit represented by Formula (5) in addition to the structural unit represented by Formula (1) and the structural unit represented by Formula (2).

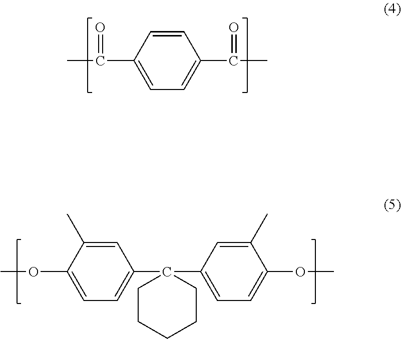

When the polyester resin has a structural unit represented by Formula (4) and a structural unit represented by Formula (5), the solubility of the polyester resin in a solvent is improved, and the photosensitive layer can be satisfactorily formed.

In the polyester resin, the substance amount of the structural unit represented by Formula (1) is defined as M1, and the substance amount of the structural unit represented by Formula (4) is defined as M4. Further, a ratio (M1/(M1+M4)) of M1 to the total substance amount of M1 and M4 can be set to be greater than 0.30 from the viewpoint of suppressing a decrease in transfer efficiency. The ratio (M1/(M1+M4)) can also be set to 0.55 or greater. The substance amount is in units of “mol”.

In the polyester resin, in a case where a total substance amount of structural units derived from a carboxylic acid constituting the polyester resin is defined as MC, the substance amount of the structural unit represented by Formula (1) is defined as M1, and the substance amount of the structural unit represented by Formula (4) is defined as M4, a ratio ((M1+M4)/MC) can be set to 0.50 or greater.

In the polyester resin, in a case where the total substance amount of structural units derived from a carboxylic acid constituting the polyester resin is defined as MC and the substance amount of the structural unit represented by Formula (1) is defined as M1, (M1/MC)≥0.50 can be satisfied.

In the polyester resin, the substance amount of the structural unit represented by Formula (2) is defined as M2, and the substance amount of the structural unit represented by Formula (5) is defined as M5. Further, a ratio (M2/(M2+M5)) of M2 to the total substance amount of M2 and M5 can be set to be greater than 0 from the viewpoint of suppressing a decrease in transfer efficiency. Meanwhile, the ratio (M2/(M2+M5)) can also be set to 0.50 or less from the viewpoint of the solubility in a solvent. That is, M2/(M2+M5) can satisfy 0<M2/(M2+M5)≤0.50. The photosensitive layer can be satisfactorily formed by improving the solubility in a solvent.

In the polyester resin, the substance amount of the structural unit represented by Formula (1) is defined as M1, and the substance amount of the structural unit represented by Formula (4) is defined as M4. Further, a ratio (M4/(M1+M4)) of M4 to the total substance amount of M1 and M4 can satisfy 0.30≤M4/(M1+M4)≤0.70 from the viewpoint of the solubility in a solvent.

In the polyester resin, the substance amount of the structural unit represented by Formula (2) is defined as M2, and the substance amount of the structural unit represented by Formula (5) is defined as M5. Further, a ratio (M5/(M2+M5)) of M5 to the total substance amount of M2 and M5 can be set to be less than 0.70 from the viewpoint of suppressing a decrease in transfer efficiency. Meanwhile, the ratio (M5/(M2+M5)) can also be set to 0.50 or greater from the viewpoint of the solubility in a solvent.

In the polyester resin, in a case where a total substance amount of structural units derived from bisphenol constituting the polyester resin is defined as MB, the substance amount of the structural unit represented by Formula (2) is defined as M2, and the substance amount of the structural unit represented by Formula (5) is defined as M5, a ratio ((M2+M5)/MB) can be set to 0.50 or greater.

The photosensitive layer may contain resins other than the polyester resin. Examples of the other resins include a polycarbonate resin, a styrene resin, and an acrylic resin. The polyarylate resin may be a random copolymer, an alternating copolymer, a periodic copolymer, or a block copolymer.

The viscosity average molecular weight of the polyester resin (PAR) can be set to 10,000 or greater, 30,000 or greater, or 50,000 or greater. When the viscosity average molecular weight of the polyester resin (PAR) is 10,000 or greater, the wear resistance of the photosensitive member is improved. Meanwhile, the viscosity average molecular weight of the polyester resin (PAR) can be set to 80,000 or less or 70,000 or less.

When the viscosity average molecular weight of the polyester resin (PAR) is 80,000 or less, the polyester resin (PAR) is easily dissolved in a solvent for forming a photosensitive layer.

In the present disclosure, the polyester resin is configured to have a structural unit represented by Formula (2) as a repeating unit derived from bisphenol and a structural unit represented by Formula (1) as a repeating unit derived from a dicarboxylic acid. Further, in the present disclosure, the polyester resin can be configured to further have a structural unit represented by Formula (5) as a repeating unit derived from bisphenol and a structural unit represented by Formula (4) as a repeating unit derived from a dicarboxylic acid. Examples of the bisphenol for constituting the repeating unit derived from bisphenol include a compound represented by Formula (BP-2) and a compound represented by Formula (BP-5) (hereinafter, also referred to as a compound (BP-2) and a compound (BP-5)).

Examples of the dicarboxylic acid for constituting the repeating unit derived from a dicarboxylic acid include a compound represented by Formula (DC-1) and a compound represented by Formula (DC-4) (hereinafter, also referred to as a compound (DC-1) and a compound (DC-4)). The proportion of the bisphenol in the resin (that is, the content ratio of the structural unit represented by Formula (2) and the structural unit represented by Formula (5)) can be adjusted by changing the amount of the compound (BP-2) and the amount of the compound (BP-5) to be added in a case of producing the polyester resin (PAR). Further, the same applies to the amount of the dicarboxylic acid, and thus the proportion of the dicarboxylic acid in the resin (that is, the content ratio of the structural unit represented by Formula (1) and the structural unit represented by Formula (4)) can be adjusted by changing the amount of the compound (DC-1) and the amount of the compound (DC-4) to be added in a case of producing the polyester resin (PAR).

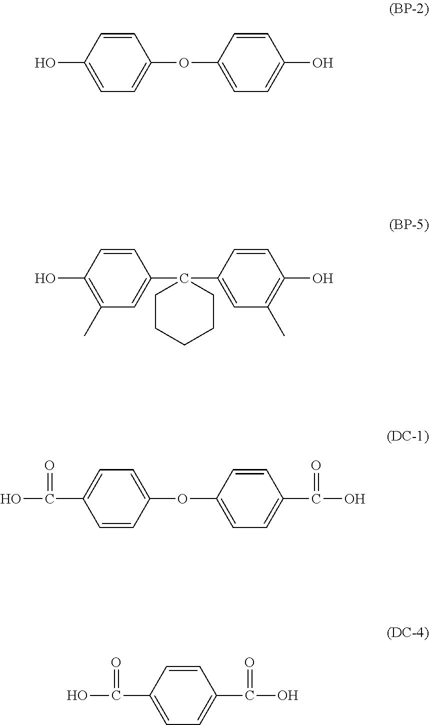

The bisphenol (for example, the compound (BP-2) and the compound (BP-5)) may be used by being derivatized to aromatic diacetate. The dicarboxylic acid (for example, the compound (DC-1) and the compound (DC-4)) may be used by being derivatized. Examples of the derivative of the dicarboxylic acid include dicarboxylic acid dichloride, dicarboxylic acid dimethyl ester, dicarboxylic acid diethyl ester, and a dicarboxylic anhydride. The dicarboxylic acid dichloride is a compound in which two “—C(═O)—OH” groups of the dicarboxylic acid are each substituted with a “—C(═O)—Cl” group.

In condensation polymerization of the bisphenol and the dicarboxylic acid, one or both of a base and a catalyst may be added. Examples of the base include sodium hydroxide. Examples of the catalyst include benzyltributylammonium chloride, ammonium chloride, ammonium bromide, a quaternary ammonium salt, triethylamine, and trimethylamine.

The photosensitive layer may contain only the polyester resin (PAR) having a structural unit represented by Formula (1) and a structural unit represented by Formula (2) and may further contain binder resins other than the polyester resin (hereinafter, also referred to as other binder resins contained in the photosensitive layer). Examples of the other binder resins contained in the photosensitive layer include thermoplastic resins (more specifically, a polyester resin other than the polyester resin (PAR) in the present disclosure, a polycarbonate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, and a polyether resin), thermosetting resins (more specifically, a silicone resin, an epoxy resin, a phenol resin, a urea resin, a melamine resin, and other crosslinkable thermosetting resins), and photocurable resins (more specifically, an epoxy-acrylic acid-based resin and a urethane-acrylic acid-based copolymer). The binder resin contained in the photosensitive layer can contain 50% by mass or greater of the polyester resin having a structural unit represented by Formula (1) and a structural unit represented by Formula (2) with respect to the total mass of the binder resin.

### Charge Generating Material

Examples of the charge generating material include a phthalocyanine-based pigment, a perylene-based pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of an inorganic photoconductive material (such as selenium, selenium-tellurium, selenium-arsenic, cadmium sulfide, or amorphous silicon), a pyrylium pigment, an anthanthrone-based pigment, a triphenylmethane-based pigment, a threne-based pigment, a toluidine-based pigment, a pyrazoline-based pigment, and a quinacridone-based pigment. The photosensitive layer may contain only one or two or more kinds of charge generating materials.

The phthalocyanine-based pigment is a pigment having a phthalocyanine structure. Examples of the phthalocyanine-based pigment include metal-free phthalocyanine and metal phthalocyanine.

Examples of the metal phthalocyanine include titanyl phthalocyanine, hydroxy gallium phthalocyanine, and chlorogallium phthalocyanine. Titanyl phthalocyanine can be used as the metal phthalocyanine. The titanyl phthalocyanine is a compound represented by Formula (CGM-1), and the metal-free phthalocyanine is a compound represented by Formula (CGM-2).

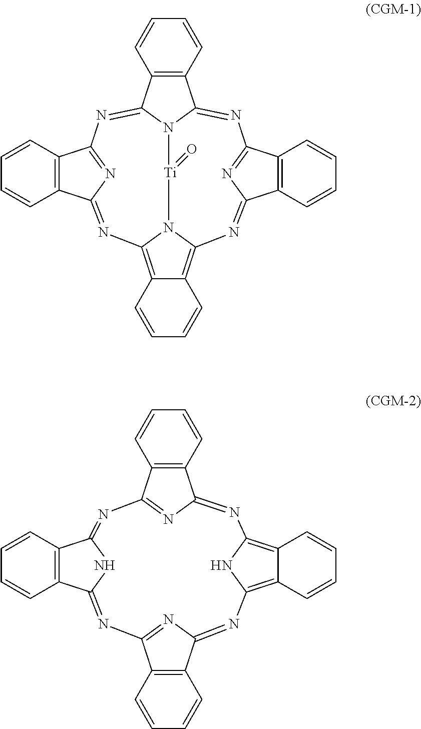

The phthalocyanine-based pigment may be crystalline or non-crystalline. Examples of the crystal of the metal-free phthalocyanine include an X-type crystal of metal-free phthalocyanine (hereinafter, also referred to as X-type metal-free phthalocyanine). Examples of the crystal of titanyl phthalocyanine include an α-type crystal, a β-type crystal, and a Y-type crystal of titanyl phthalocyanine (hereinafter, each also referred to as α-type titanyl phthalocyanine, β-type titanyl phthalocyanine, and Y-type titanyl phthalocyanine). As a digital optical electrophotographic apparatus (for example, a laser beam printer or a facsimile, for which a light source such as a semiconductor laser is used), for example, a photosensitive member having sensitivity in a wavelength range of 700 nm or greater can be used. From the viewpoint of having a high quantum yield in a wavelength range of 700 nm or greater, a phthalocyanine-based pigment is suitable, metal-free phthalocyanine or titanyl phthalocyanine is more suitable, and titanyl phthalocyanine is still more suitable as the charge generating material. Among these, Y-type titanyl phthalocyanine is particularly suitable.

The Y-type titanyl phthalocyanine has, for example, a main peak at a Bragg angle (2θ±0.2°) of 27.2° in a CuKα characteristic X-ray diffraction spectrum. The main peak in a CuKα characteristic X-ray diffraction spectrum is a peak having the first or second highest intensity in a Bragg angle range (2θ±0.2°) of 3° or greater and 400 or less. The Y-type titanyl phthalocyanine has no peak at 26.2° in the CuKα characteristic X-ray diffraction spectrum.

The CuKα characteristic X-ray diffraction spectrum can be measured, for example, by the following method. For example, a sample holder of an X-ray diffractometer (for example, “RINT (registered trademark) 1100”, manufactured by Rigaku Corporation) is filled with a sample, and the X-ray diffraction spectrum is measured under conditions of an X-ray tube of Cu, a tube voltage of 40 kV, a tube current of 30 mA, and a CuKα characteristic X-ray having a wavelength of 1.542 Å. The measurement is performed, for example, in an angle range (2θ) of 3° or greater and 40° or less (a start angle of 3° and a stop angle of 40°), and the scanning speed is, for example, 10°/min. The main peak is determined from the obtained X-ray diffraction spectrum, and the Bragg angle of the main peak is read.

The content of the charge generating material can be set to 0.1 parts by mass or greater and 50 parts by mass or less, or 0.5 parts by mass or greater and 5 parts by mass or less with respect to 100 parts by mass of the binder resin.

### Electron Transporting Material

The electron transporting material can contain at least one selected from the group consisting of a compound represented by Formula (10), a compound represented by Formula (11), a compound represented by Formula (12), a compound represented by Formula (13), a compound represented by Formula (14), a compound represented by Formula (15), and a compound represented by Formula (16). It is considered that when the photosensitive layer contains the above-described electron transporting material, the compatibility between the binder resin in the present disclosure and the hole transporting material described below is increased, the homogeneity inside the photosensitive layer is enhanced, and thus the effects of the present disclosure are enhanced.

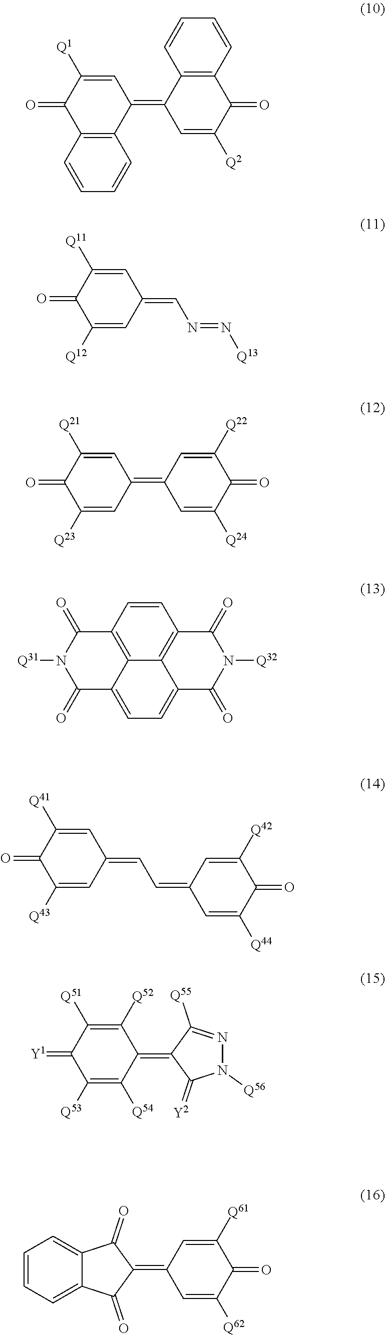

Q¹ and Q² in Formula (10), Q¹¹, Q¹², and Q¹³ in Formula (11), Q²¹, Q²², Q²³, and Q²⁴ in Formula (12), Q³¹ and Q³² in Formula (13), Q⁴¹, Q⁴², Q⁴³, and Q⁴⁴ in Formula (14), Q⁵¹, Q⁵², Q⁵³, Q⁵⁴, Q⁵⁵, and Q⁵⁶ in Formula (15), and Q⁶¹ and Q⁶² in Formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms, which may be substituted with at least one substituent selected from the group consisting of an alkyl group having 1 or more and 6 or less carbon atoms and a halogen atom. Y¹ and Y² in Formula (15) each independently represent an oxygen atom or a sulfur atom.

Q¹ and Q² in Formula (10), Q¹¹ to Q¹³ in Formula (11), Q²¹ to Q²⁴ in Formula (12), Q³¹ and Q³² in Formula (13), Q⁴¹ to Q⁴⁴ in Formula (14), Q⁵¹ to Q⁵⁶ in Formula (15), and Q⁶¹ and Q⁶² in Formula (16) each can independently represent a hydrogen atom, an alkyl group having 1 or more and 6 or less carbon atoms, or an aryl group having 6 or more and 14 or less carbon atoms, which may be substituted with at least one substituent selected from the group consisting of an alkyl group having 1 or more and 6 or less carbon atoms and a halogen atom. Y¹ and Y² in Formula (15) can represent an oxygen atom.

In a case where Q¹ and Q² in Formula (10), Q¹¹ to Q¹³ in Formula (11), Q²¹ to Q²⁴ in Formula (12), Q³¹ and Q³² in Formula (13), Q⁴¹ to Q⁴⁴ in Formula (14), Q⁵¹ to Q⁵⁶ in Formula (15), and Q⁶¹ and Q⁶² in Formula (16) each represent an alkyl group having 1 or more and 6 or less carbon atoms, these each can represent an alkyl group having 1 or more and 5 or less carbon atoms, suitably a methyl group, an ethyl group, a propyl group, a butyl group, or a pentyl group, and particularly suitably a methyl group, an isopropyl group, a tert-butyl group, or a 1,1-dimethylpropyl group.

In a case where Q¹ and Q² in Formula (10), Q¹¹ to Q¹³ in Formula (11), Q²¹ to Q²⁴ in Formula (12), Q³¹ and Q³² in Formula (13), Q⁴¹ to Q⁴⁴ in Formula (14), Q⁵¹ to Q⁵⁶ in Formula (15), and Q⁶¹ and Q⁶² in Formula (16) each represent an aryl group having 6 or more and 14 or less carbon atoms, these each can represent suitably an aryl group having 6 or more and 10 or less carbon atoms and more suitably a phenyl group. The aryl group having 6 or more and 14 or less carbon atoms may be substituted with at least one substituent selected from the group consisting of an alkyl group having 1 or more and 6 or less carbon atoms and a halogen atom. The alkyl group having 1 or more and 6 or less carbon atoms as a substituent is suitably an alkyl group having 1 or more and 3 or less carbon atoms and more suitably a methyl group or an ethyl group. The halogen atom as a substituent is suitably a fluorine atom, a chlorine atom, or a bromine atom and particularly suitably a chlorine atom. In a case where the aryl group having 6 or more and 14 or less carbon atoms is substituted with a substituent, the number of substituents is suitably 1 or more and 5 or less and more suitably 1 or 2. The aryl group having 6 or more and 14 or less carbon atoms, which is substituted with at least one substituent selected from the group consisting of an alkyl group having 1 or more and 6 or less carbon atoms and a halogen atom, is suitably a chlorophenyl group, a dichlorophenyl group, or an ethylmethylphenyl group and more suitably a 4-chlorophenyl group, a 2,5-dichlorophenyl group, or a 2-ethyl-6-methylphenyl group.

Suitable examples of the compound represented by Formula (10) include a compound represented by Formula (E-4). Suitable examples of the compound represented by Formula (11) include a compound represented by Formula (E-5). Suitable examples of the compound represented by Formula (12) include a compound represented by Formula (E-7). Suitable examples of the compound represented by Formula (13) include a compound represented by Formula (E-6). Suitable examples of the compound represented by Formula (14) include a compound represented by Formula (E-8). Suitable examples of the compound represented by Formula (15) include a compound represented by Formula (E-2) and a compound represented by Formula (E-3).

Suitable examples of the compound represented by Formula (16) include a compound represented by Formula (E-1). Hereinafter, compounds represented by Formulae (E-1) to (E-8) will each also be referred to as electron transporting materials (E-1) to (E-8).

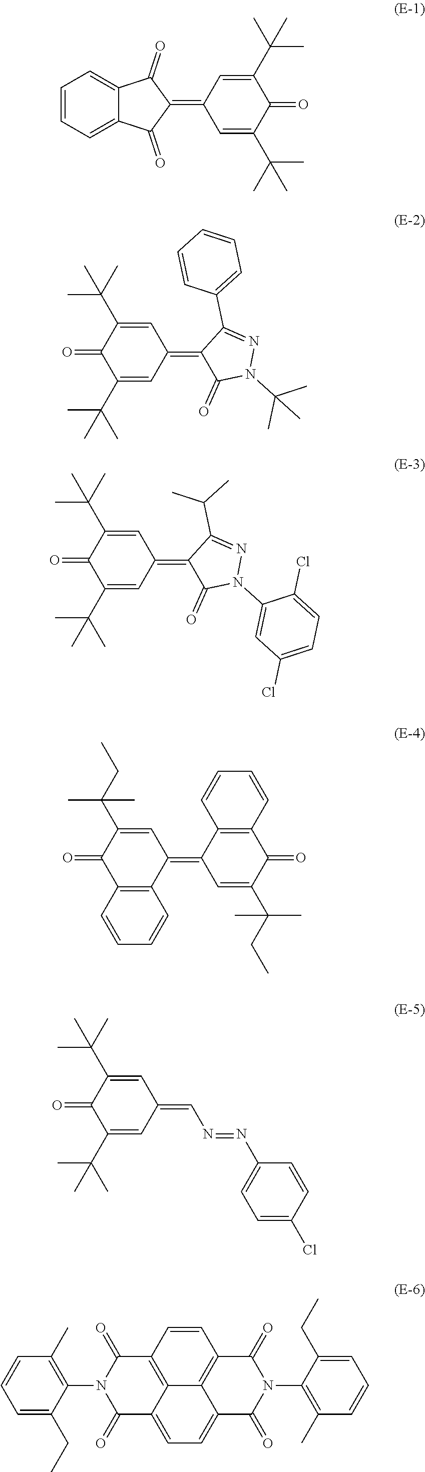

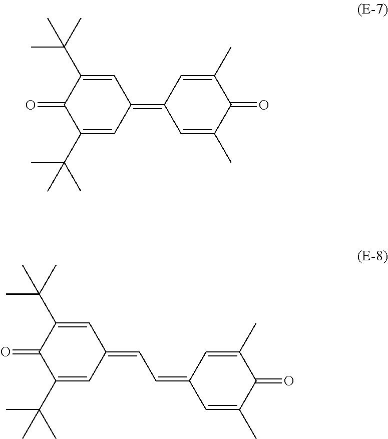 [SMILES: CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

The content of the electron transporting material can be set to 5% by mass or greater and 150 parts by mass or less, 10 parts by mass or greater and 100 parts by mass, or 30 parts by mass or greater and 70 parts by mass or less with respect to 100 parts by mass of the binder resin. The photosensitive layer may contain only one or two or more kinds of electron transporting materials.

### Hole Transporting Material

Examples of the hole transporting material include a compound represented by Formula (20), a compound represented by Formula (21), a compound represented by Formula (22), a compound represented by Formula (23), and a compound represented by Formula (24). It is considered that when the photosensitive layer contains the above-described hole transporting material, the compatibility between the binder resin and the electron transporting material in the present disclosure is increased, the homogeneity inside the photosensitive layer is enhanced, and thus the effects of the present disclosure are enhanced.

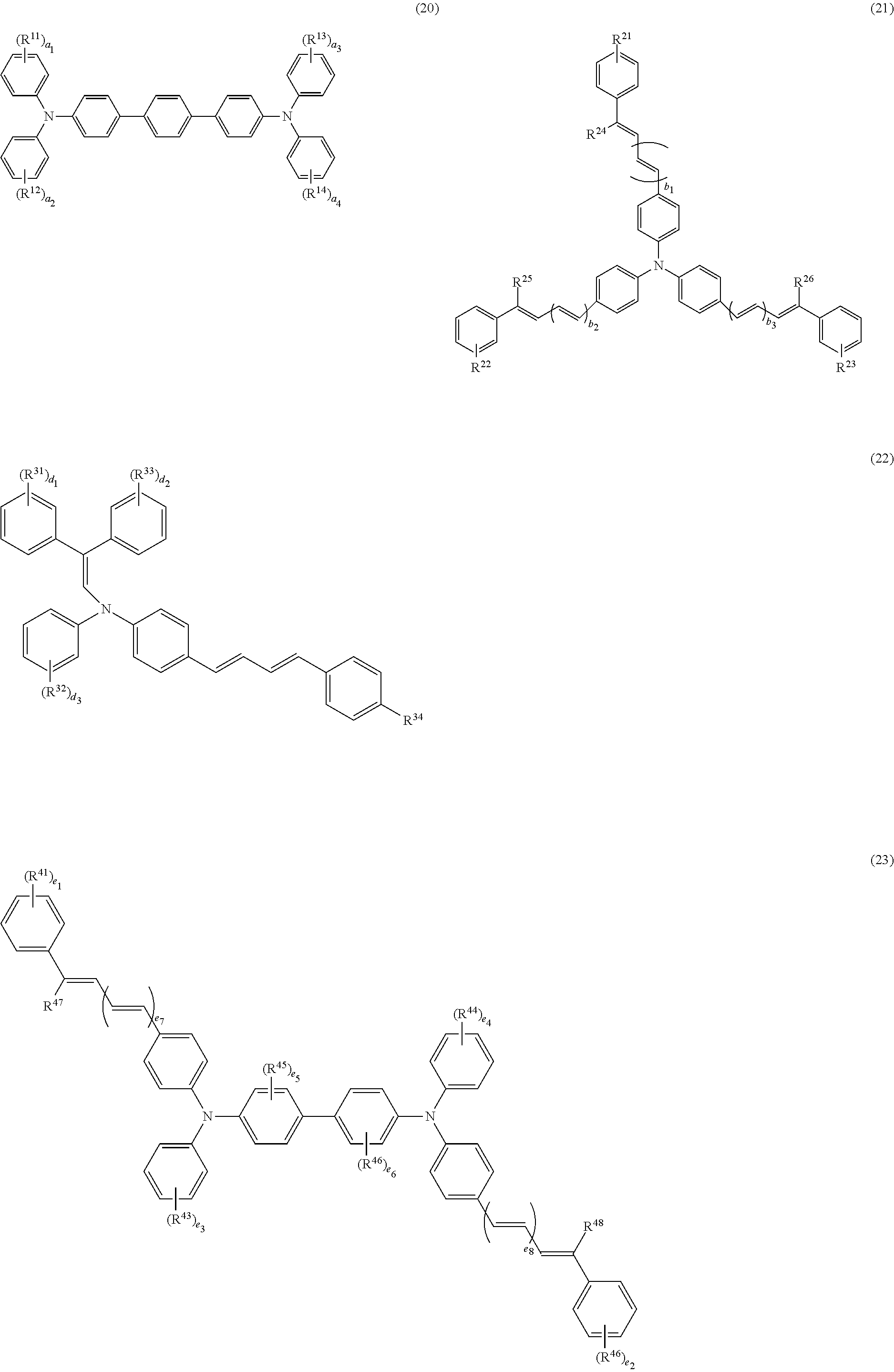

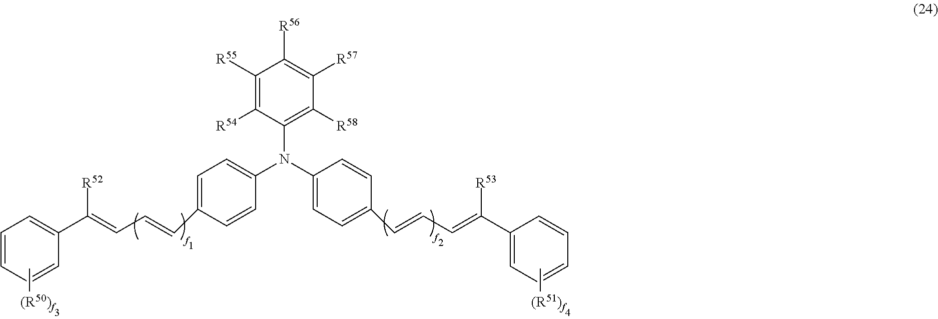

In Formula (20), R¹¹, R¹², R¹³, and R¹⁴ each independently represent an alkyl group having 1 or more and 6 or less carbon atoms or an alkoxy group having 1 or more and 6 or less carbon atoms. a₁, a₂, a₃, and a₄ each independently represent an integer of 0 or greater and 5 or less. In Formula (20), when a₁ represents an integer of 2 or greater and 5 or less, a plurality of R¹¹'s may represent groups that are the same as or different from each other. When a₂ represents an integer of 2 or greater and 5 or less, a plurality of R¹²'s may represent groups that are the same as or different from each other. When a₃ represents an integer of 2 or greater and 5 or less, a plurality of R¹³'s may represent groups that are the same as or different from each other. When a₄ represents an integer of 2 or greater and 5 or less, a plurality of R¹⁴'s may represent groups that are the same as or different from each other. In Formula (20), R¹¹, R¹², R¹³, and R¹⁴ each independently represent suitably an alkyl group having 1 or more and 3 or less carbon atoms and more suitably a methyl group or an ethyl group. a₁, a₂, a₃, and a₄ each independently represent suitably an integer of 1 or greater and 3 or less and more suitably 1.

In Formula (21), R²¹, R²², and R²³ each independently represent an alkyl group having 1 or more and 6 or less carbon atoms. R²⁴, R²⁵, and R²⁶ each independently represent a hydrogen atom or an alkyl group having 1 or more and 6 or less carbon atoms. b₁, b₂, and b₃ each independently represent 0 or 1. In Formula (21), R²¹, R²², and R²³ each independently represent suitably an alkyl group having 1 or more and 3 or less carbon atoms and more suitably a methyl group. The bonding position of R²¹, R²², and R²³ in a phenyl group may be a meta position with respect to a bonding position of the phenyl group to a triphenylamine structure. R²⁴, R²⁵, and R²⁶ each can represent a hydrogen atom. All of b₁, b₂, and b₃ can represent 0 or 1.

In Formula (22), R³¹, R³², and R³³ each independently represent an alkyl group having 1 or more and 6 or less carbon atoms. R³⁴ represents an alkyl group having 1 or more and 6 or less carbon atoms or a hydrogen atom. d₁, d₂, and d₃ each independently represent an integer of 0 or greater and 5 or less. In Formula (22), when d₁ represents an integer of 2 or greater and 5 or less, a plurality of R³¹'s may represent groups that are the same as or different from each other. When d₂ represents an integer of 2 or greater and 5 or less, a plurality of R³²'s may represent groups that are the same as or different from each other. When d₃ represents an integer of 2 or greater and 5 or less, a plurality of R³³'s may represent groups that are the same as or different from each other. In Formula (22), R³⁴ can represent a hydrogen atom. d₁, d₂, and d₃ each can represent 0.

In Formula (23), R⁴¹, R⁴², R⁴³, R⁴⁴, R⁴⁵, and R⁴⁶ each independently represent an alkyl group having 1 or more and 6 or less carbon atoms or a phenyl group. R⁴⁷ and R⁴⁸ each independently represent a hydrogen atom, an alkyl group having 1 or more and 6 or less carbon atoms, or a phenyl group.

e₁, e₂, e₃, and e₄ each independently represent an integer of 0 or greater and 5 or less. e₅ and e₆ each independently represent an integer of 0 or greater and 4 or less. e₇ and e₅ each independently represent 0 or 1. In Formula (23), when e₁ represents an integer of 2 or greater and 5 or less, a plurality of R⁴¹'s may represent groups that are the same as or different from each other. When e₂ represents an integer of 2 or greater and 5 or less, a plurality of R⁴²'s may represent groups that are the same as or different from each other. When e₃ represents an integer of 2 or greater and 5 or less, a plurality of R⁴³'s may represent groups that are the same as or different from each other. When e₄ represents an integer of 2 or greater and 5 or less, a plurality of R⁴⁴'s may represent groups that are the same as or different from each other. When e₅ represents an integer of 2 or greater and 5 or less, a plurality of R⁴⁵'s may represent groups that are the same as or different from each other. When e₆ represents an integer of 2 or greater and 5 or less, a plurality of R⁴⁶'s may represent groups that are the same as or different from each other. In Formula (23), R⁴¹ to R⁴⁶ each independently represent suitably an alkyl group having 1 or more and 6 or less carbon atoms, more suitably an alkyl group having 1 or more and 3 or less carbon atoms, and still more suitably a methyl group or an ethyl group. R⁴⁷ and R⁴⁸ can represent a hydrogen atom. e₁, e₂, e₃, and e₄ each can independently represent an integer of 0 or greater and 2 or less. Here, e₁ and e₂ can represent 0, and e₃ and e₄ can represent 2. e₅ and e₆ can represent 0. Both e₇ and e₈ can represent 0 or 1.

In Formula (24), R⁵⁰ and R⁵¹ each independently represent an alkyl group having 1 or more and 6 or less carbon atoms, an alkoxy group having 1 or more and 6 or less carbon atoms, or a phenyl group. R⁵², R⁵³, R⁵⁴, R⁵⁵, R⁵⁶, R⁵⁷, and R⁵¹ each independently represent a hydrogen atom, an alkyl group having 1 or more and 6 or less carbon atoms, an alkoxy group having 1 or more and 6 or less carbon atoms, or a phenyl group which may be substituted with an alkyl group having 1 or more and 6 or less carbon atoms. f₁ and f₂ each independently represent an integer of 0 or greater and 2 or less. f₃ and f₄ each independently represent an integer of 0 or greater and 5 or less. In Formula (24), when f₃ represents an integer of 2 or greater and 5 or less, a plurality of R⁵⁰'s may represent groups that are the same as or different from each other. When f₄ represents an integer of 2 or greater and 5 or less, a plurality of R⁵¹'s may represent groups that are the same as or different from each other. In Formula (24), R⁵⁰ and R⁵¹ each can independently represent an alkyl group having 1 or more and 6 or less carbon atoms. R⁵² and R⁵³ each can represent a hydrogen atom or a phenyl group which may be substituted with an alkyl group having 1 or more and 6 or less carbon atoms. R⁵⁴ to R⁵¹ each can independently represent a hydrogen atom, an alkyl group having 1 or more and 6 or less carbon atoms, or an alkoxy group having 1 or more and 6 or less carbon atoms. Both f₁ and f₂ can represent 0, 1, or 2. f₃ and f₄ each can independently represent 0 or 1. When R^{5′} and R⁵¹ each represent an alkyl group having 1 or more and 6 or less carbon atoms, R^{5′} and R⁵¹ represent suitably an alkyl group having 1 or more and 3 or less carbon atoms and more suitably a methyl group. When R⁵² and R⁵³ each represent a phenyl group which may be substituted with an alkyl group having 1 or more and 6 or less carbon atoms, R⁵² and R⁵³ can represent a phenyl group or a phenyl group substituted with an alkyl group having 1 or more and 3 or less carbon atoms. The phenyl group substituted with an alkyl group having 1 or more and 3 or less carbon atoms is suitably a methylphenyl group and more suitably a 4-methylphenyl group. When R⁵⁴ to R⁵⁸ each represent an alkyl group having 1 or more and 6 or less carbon atoms, R⁵⁴ to R⁵¹ represent suitably an alkyl group having 1 or more and 4 or less carbon atoms and more suitably a methyl group, an ethyl group, or an n-butyl group. When R⁵⁴ to R⁵⁸ each represent an alkoxy group having 1 or more and 6 or less carbon atoms, R⁵⁴ to R⁵⁸ represent suitably an alkoxy group having 1 or more and 3 or less carbon atoms and more suitably an ethoxy group.

Suitable examples of the compound represented by Formula (20) include a compound represented by Formula (H-11). Suitable examples of the compound represented by Formula (21) include a compound represented by Formula (H-7) and a compound represented by Formula (H-8). Suitable examples of the compound represented by Formula (22) include a compound represented by Formula (H-6). Suitable examples of the compound represented by Formula (23) include a compound represented by Formula (H-9) and a compound represented by Formula (H-10). Suitable examples of the compound represented by Formula (24) include a compound represented by Formula (H-1), a compound represented by Formula (H-2), a compound represented by Formula (H-3), a compound represented by Formula (H-4), and a compound represented by Formula (H-5). Hereinafter, the compounds represented by Formulae (H-1) to (H-11) will each also be referred to as hole transporting materials (H-1) to (H-11).

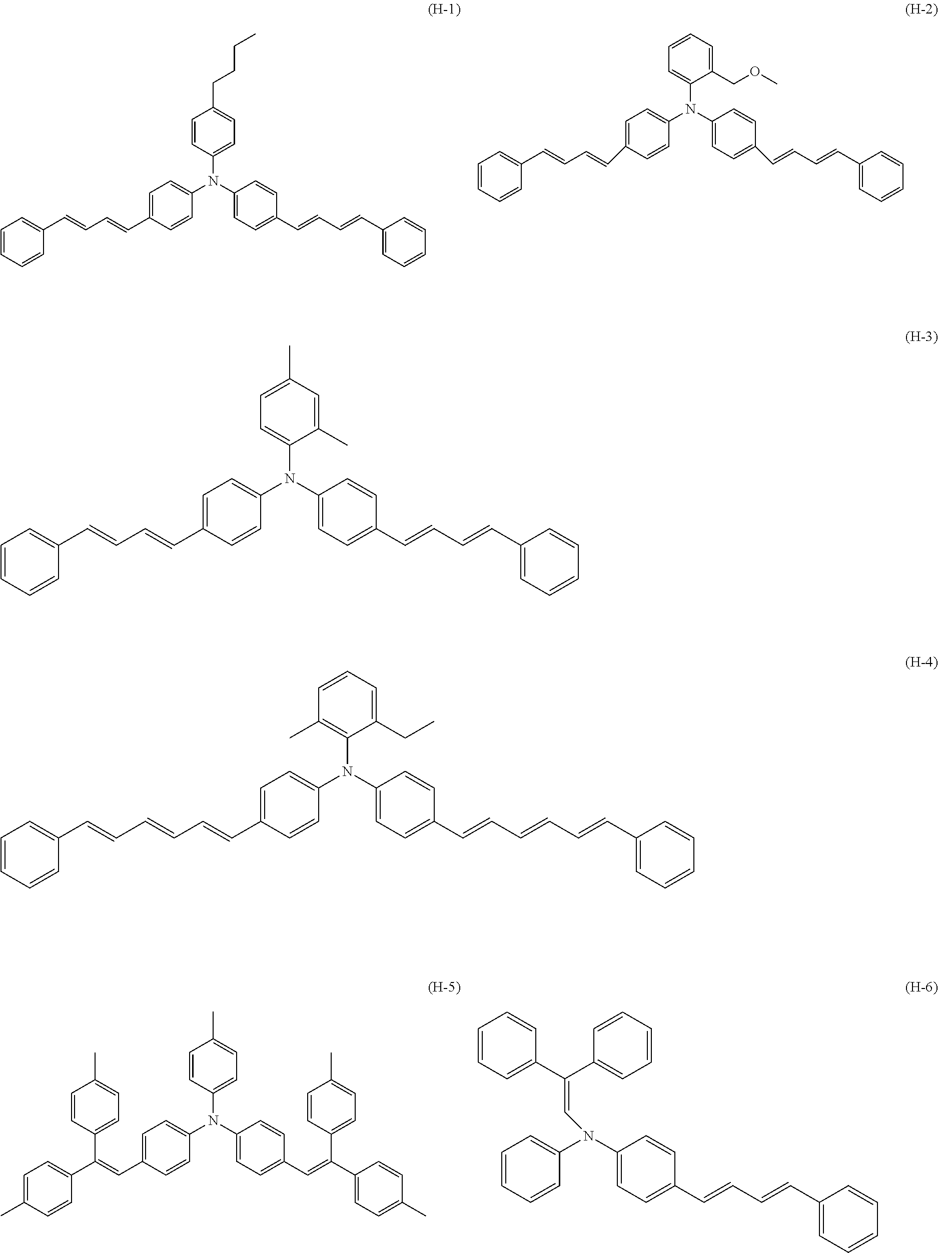

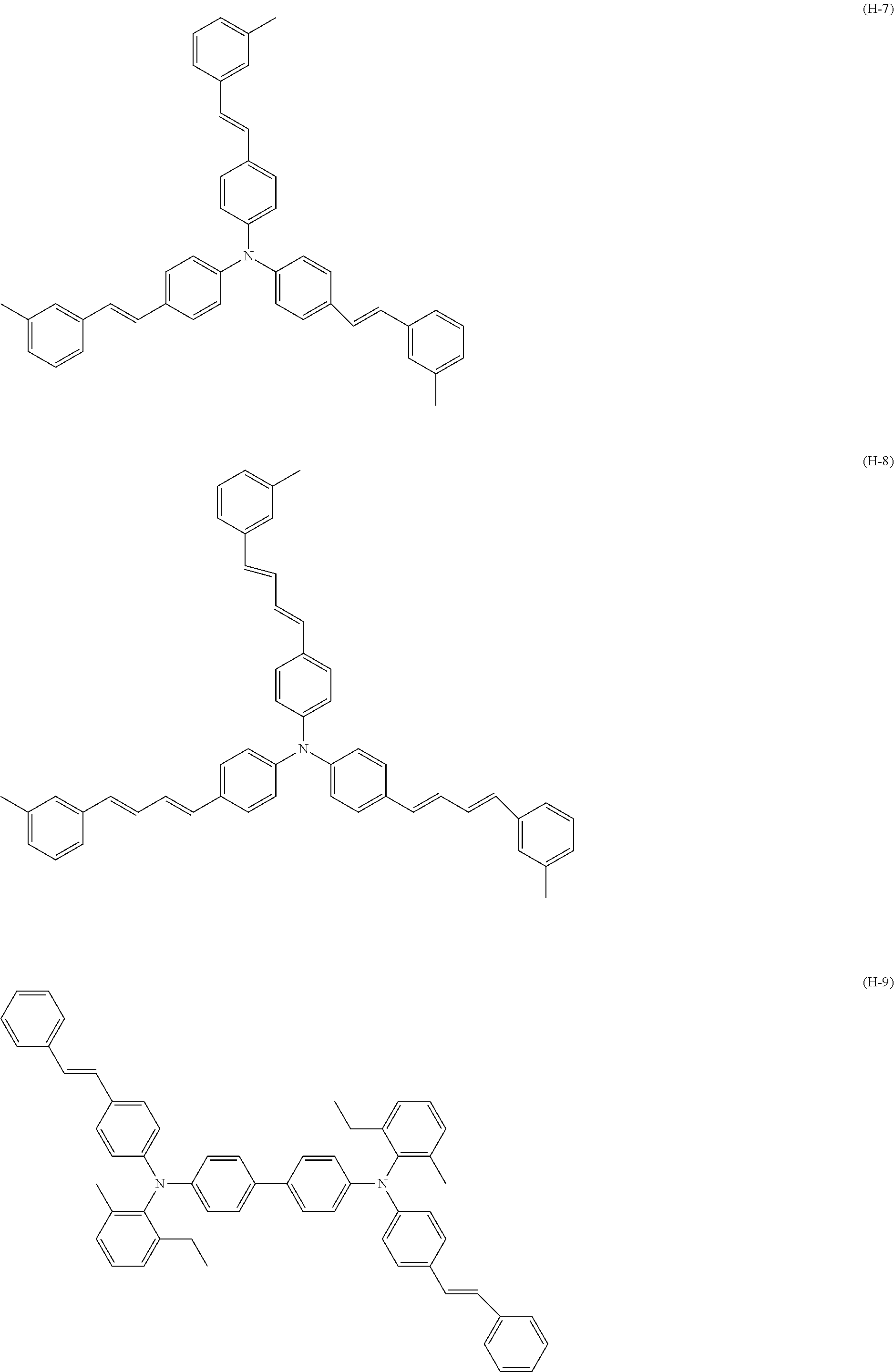 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1]

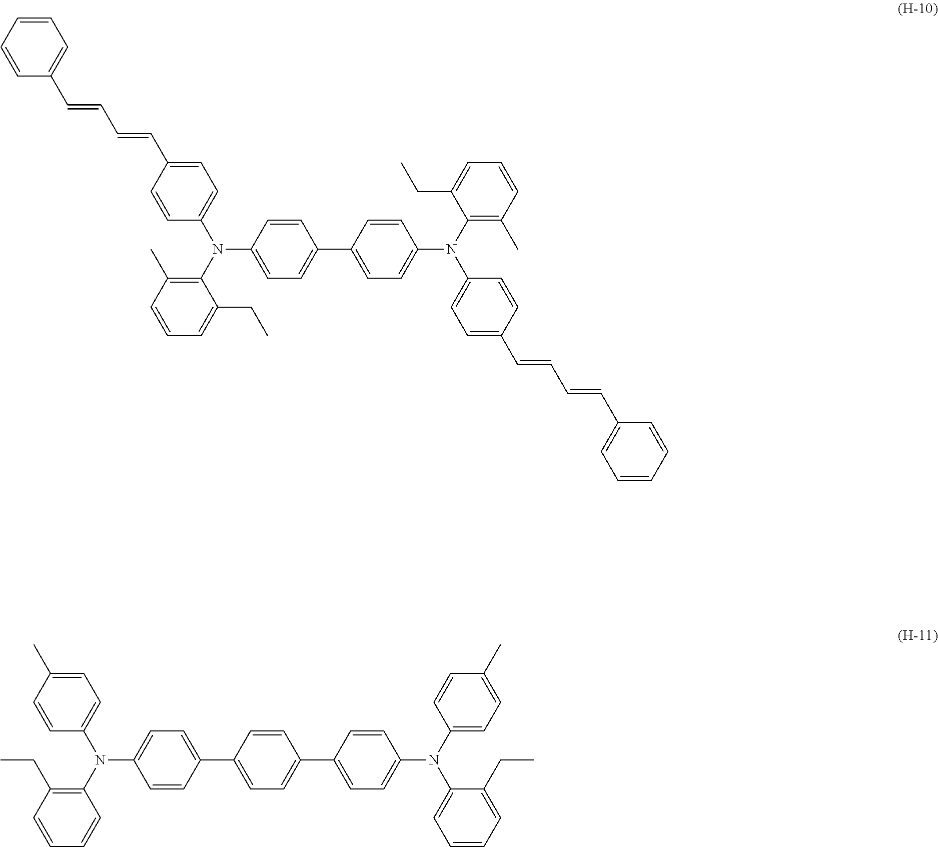 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

The content of the hole transporting material can be set to 10 parts by mass or greater and 200 parts by mass, 30 parts by mass or greater and 120 parts by mass or less, or 50 parts by mass or greater and 90 parts by mass or less with respect to 100 parts by mass of the binder resin. The photosensitive layer may contain only one or two or more kinds of hole transporting materials. Further, the photosensitive layer may further contain hole transporting materials other than the compound represented by Formula (20), (21), (22), (23), or (24) (hereinafter, also referred to as other hole transporting materials). Examples of the other hole transporting materials include a triphenylamine derivative, a diamine derivative (such as a N,N,N′,N′-tetraphenylbenzidine derivative, a N,N,N′,N′-tetraphenylphenylenediamine derivative, a N,N,N′,N′-tetraphenylnaphthylenediamine derivative, a N,N,N′,N′-tetraphenylphenanthrylenediamine derivative, or a di(aminophenylethenyl)benzene derivative), an oxadiazole-based compound (such as 2,5-di(4-methylaminophenyl)-1,3,4-oxadiazole), a styryl-based compound (such as 9(4-diethylaminostyryl)anthracene), a carbazole-based compound (such as polyvinylcarbazole), an organic polysilane compound, a pyrazoline-based compound (such as 1-phenyl-3-(p-dimethylaminophenyl)pyrazoline), a hydrazone-based compound, an indole-based compound, an oxazole-based compound, an isoxazole-based compound, a thiazole-based compound, a thiadiazole-based compound, an imidazole-based compound, a pyrazole-based compound, and a triazole-based compound.

### Additive

The photosensitive layer may contain an additive as necessary. Examples of the additive include an ultraviolet absorber, an antioxidant, a radical scavenger, a singlet quencher, a softer, a surface modifier, an extender, a thickener, a wax, a donor, a surfactant, a plasticizer, a sensitizer, and a leveling agent. Particularly, a small amount of a compound represented by Formula (30) (hereinafter, also referred to as a compound (T-1)) can be added to the photosensitive layer.

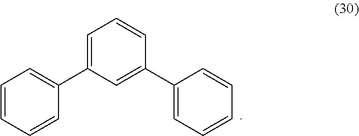 [SMILES: c1ccc(-c2cccc(-c3ccccc3)c2)cc1]

### Vickers Hardness

The photosensitive layer can have a Vickers hardness of 18.0 HV or greater, or 19.0 HV or greater. When the photosensitive layer has a Vickers hardness of 19.0 HV or greater, the film uniformity of the photosensitive member is improved, and thus the effect of leveling out the unevenness in pressing pressure is increased. The upper limit of the Vickers hardness of the photosensitive layer is not particularly limited, but is, for example, 25.0 HV or less. When the Vickers hardness thereof is extremely large, there is a possibility that the unevenness in pressing pressure is unintentionally increased. The Vickers hardness of the photosensitive layer is measured by a method in conformity with Japanese Industrial Standards (JIS) Z 2244. The Vickers hardness of the photosensitive layer is adjusted, for example, by changing the type of the binder resin and the type of the hole transporting agent or the electron transporting agent.

### Developing Roller

### Shaft Member

A developing roller 21 of the present disclosure includes a shaft member 22 as shown in FIG. 7. The material constituting the shaft member 22 is not particularly limited as long as the material has satisfactory conductivity. For example, a shaft member formed of a metal, a shaft member formed of a highly rigid resin base material, or a combination thereof can be used, or a cylindrical body formed of a metal or a highly rigid resin and having an inside hollowed out may also be used.

In a case where a highly rigid resin is used in the shaft member 22, a conductive agent may be added to and dispersed in the highly rigid resin to ensure sufficient conductivity. Here, as the conductive agent to be dispersed in a highly rigid resin, a powdery conductive agent such as carbon black powder, graphite powder, carbon fibers, metal powder such as aluminum, copper, or nickel, metal oxide powder such as tin oxide, titanium oxide, or zinc oxide, or conductive glass powder can be used. These conductive agents may be used alone or in combination of two or more kinds thereof. The amount of the conductive agent to be blended is not particularly limited, but can be set to be in a range of 5% to 40% by mass or in a range of 5% to 20% by mass with respect to the total amount of the highly rigid resin.

Examples of the material for the metal shaft member or the metal cylindrical body include iron, stainless steel, and aluminum, and may also include materials obtained by plating iron, stainless steel, or aluminum with zinc or nickel. Further, examples of the material for the highly rigid resin base material include polyacetal, polyamide 6, polyamide 6.6, polyamide 12, polyamide 4.6, polyamide 6.10, polyamide 6.12, polyamide 11, polyamide MXD6, polybutylene terephthalate, polyphenylene oxide, polyphenylene sulfide, polyethersulfone, polycarbonate, polyimide, polyamide-imide, polyetherimide, polysulfone, polyether ether ketone, polyethylene terephthalate, polyarylate, a liquid crystal polymer, polytetrafluoroethylene, polypropylene, an ABS resin, polystyrene, polyethylene, a melamine resin, a phenol resin, and a silicone resin. Among these, polyacetal, polyamide 6.6., polyamide MXD6, polyamide 6.12, polybutylene terephthalate, polyphenylene ether, polyphenylene sulfide, or polycarbonate can be used. These highly rigid resin may be used alone or in combination of two or more kinds thereof.

### Elastic Layer

The developing roller 21 of the present disclosure can include an elastic layer 23 on an outside of the shaft member 22 as shown in FIG. 7. The elastic layer 23 is not particularly limited, and can have the same configuration as an elastic layer of a known conductive roller.

The elastic layer 23 can be formed of a material, for example, an elastomer or a resin, or a foam of an elastomer or a resin. Further, an elastic member obtained by blending an electronic conductive agent such as carbon black or an ionic conductive agent such as sodium perchlorate with an elastomer alone or a foam obtained by foaming the elastomer to impart conductivity or an elastic member that is a UV-curable resin material and contains an ionic conductive agent can be used. In both cases, elastic members containing a polymer having a urethane skeleton and a conductive agent can be used.

Examples of the elastomer include silicone rubber, urethane rubber, polybutadiene-based rubber, polyisoprene-based rubber, natural rubber, styrene butadiene rubber, nitrile rubber, ethylene propylene rubber, acrylic rubber, epichlorohydrin rubber, chloroprene rubber, and mixtures thereof. Further, these elastomers can be used by being chemically foamed with a foaming agent, or can be used as a foamed body obtained by mechanically entraining air, such as a polyurethane foamed body, to foam the elastomers.

Among the elastomers alone and foamed bodies obtained by foaming the elastomers, a polyurethane foamed body obtained from a polyurethane raw material containing a polyol component and an isocyanate component is suitably used. Such a polyurethane foamed body will be described below.

The polyol component is not particularly limited, and a known raw material polyol can be used for producing a urethane foam. The polyol component can be appropriately selected from a polyether-based polyol, polyester-based polyol, a polyester polyether-based polyol, and the like depending on the applications and the like of the roller. Particularly, a polyester polyol or a polyether polyol can be used, and any one or both thereof can be mixed and used.

More specific examples of the polyether polyol include a polyether polyol obtained by addition polymerization of alkylene oxide such as polyethylene oxide or propylene oxide to glycerin or the like, a polyether polyol obtained by ring-opening polymerization of tetrahydrofuran or the like to glycerin or the like, and a polyether polyol such as polytetramethylene glycol, ethylene glycol, propanediol, or butanediol.

Further, examples of the polyester polyol include polyols such as a condensation polyester polyol obtained by condensing a dicarboxylic acid with a diol or a triol, a lactone-based polyester polyol obtained by ring-opening polymerization of a lactone based on a diol or a triol, and an ester-modified polyol in which terminals of a polyether polyol are ester-modified with a lactone.

These polyols are not particularly limited, and may have a number average molecular weight of 360 to 8,000 or 500 to 5,600. Further, the number of functional groups can be set to 2.0 to 3.

Examples of the isocyanate component include tolylene diisocyanate (TDI), prepolymerized tolylene diisocyanate (prepolymerized TDI), diphenylmethane diisocyanate (MDI), crude diphenylmethane diisocyanate (crude MDI), isophorone diisocyanate (IPDI), hydrogenated diphenylmethane diisocyanate, hydrogenated tolylene diisocyanate, hexamethylene diisocyanate (HDI), and isocyanurate-modified products, carbodiimide-modified products, and glycol-modified products thereof. These may be used alone or in combination of two or more kinds thereof. Among these, isophorone diisocyanate and tolylene diisocyanate can be used.

The isocyanate may be prepolymerized with a polyol in advance, and examples of the method thereof include a method of warming isocyanate and a polyol suitably at 40° C. to 70° C. for 6 to 240 hours and more suitably for 24 to 72 hours. In this case, the ratio between the amounts of the polyol and the isocyanate to be blended can be adjusted such that the content ratio of the isocyanate of the prepolymer to be obtained reaches 4% to 30% by mass or 6% to 15% by mass. When the content ratio of the isocyanate is less than 4% by mass, there is a concern that the stability of the prepolymer is impaired, and the prepolymer is cured during storage, which makes it difficult to use. Further, when the content ratio of the isocyanate is greater than 30% by mass, the content of the non-prepolymerized isocyanate is increased, this isocyanate and the polyol component used for the subsequent polyurethane curing reaction are cured by a reaction mechanism similar to a one-shot production method in which a prepolymerization reaction is not carried out, and thus the effect of using the prepolymer method is reduced. As the polyol component in a case of using an isocyanate component obtained by prepolymerizing isocyanate with a polyol in advance, diols such as ethylene glycol and butanediol, polyols such as trimethylolpropane and sorbitol, and derivatives thereof can also be used in addition to the polyol component described below.

The polyol component can include polyether polyol, polyester polyol, polybutadiene polyol, hydrogenated polybutadiene polyol, alkylene oxide-modified polybutadiene polyol, polyisoprene polyol, and the like. Further, polyether polyol can be obtained by addition polymerization of ethylene oxide or propylene oxide with a polyhydric alcohol or a polyvalent amine in the presence of a basic catalyst. Examples of the polyhydric alcohol and the polyvalent amine include propylene glycol, ethylene glycol, glycerin, trimethylolpropane, triethanolamine, pentaerythritol, ethylenediamine, an aromatic diamine, diethylenetriamine, sorbitol, and sucrose.

Further, the polyester polyol can be obtained by dehydration condensation of a carboxylic acid and a polyhydric alcohol. Examples of the carboxylic acid include adipic acid and phthalic acid, and examples of the polyhydric alcohol include ethylene glycol, 1,4-butanediol, 1,6-hexanediol, 3-methyl-1,5-pentanediol, 1,9-nonanediol, and the above-described polyhydric alcohols.

Polyurethane is typically blended with a conductive agent to impart or adjust the conductivity. As the conductive agent, various ionic conductive agents or electronic conductive agents can be used, and ionic conductive agents and electronic conductive agents can be used in combination.

Examples of the ionic conductive agent include an ammonium salt such as a perchlorate, a chlorate, a hydrochloride, a bromate, an iodate, a fluoroborate, a sulfate, an ethyl sulfate, a carboxylate, or a sulfonate of tetraethylammonium, tetrabutylammonium, dodecyltrimethylammonium (such as lauryltrimethylammonium), hexadecyltrimethylammonium, octadecyltrimethylammonium (such as stearyltrimethylammonium), benzyltrimethylammonium, or modified fatty acid dimethyl ethyl ammonium, and a perchlorate, a chlorate, a hydrochloride, a bromate, an iodate, a fluoroborate, a trifluoromethyl sulfate, and a sulfonate of an alkali metal and an alkali earth metal such as lithium, sodium, potassium, calcium, and magnesium.

Further, examples of the electronic conductive agent include conductive carbon such as ketjen black or acetylene black, carbon for rubber such as SAF, ISAF, HAF, FEF, GPF, SRF, FT, or MT, carbon for an ink on which an oxidation treatment has been performed, pyrolytic carbon, natural graphite, artificial graphite, a conductive metal oxide such as tin oxide, titanium oxide, or zinc oxide, and a metal such as nickel, copper, silver, or germanium.

Further, an appropriate amount of a known additive such as a foam stabilizer, a crosslinking agent, a surfactant, a catalyst, or a polymerization initiator can be added as necessary to polyurethane in addition to the polyol component, the isocyanate component, and the conductive agent.

Examples of the catalyst used for the curing reaction of polyurethane include monoamines such as triethylamine and dimethylcyclohexylamine, diamines such as tetramethylethylenediamine, tetramethylpropanediamine, and tetramethylhexanediamine, triamines such as pentamethyldiethylenetriamine, pentamethyldipropylenetriamine, and tetramethylguanidine, cyclic amines such as triethylenediamine, dimethylpiperazine, methylethylpiperazine, methylmorpholine, dimethylaminoethylmorpholine, and dimethylimidazole, alcoholamines such as dimethylaminoethanol, dimethylaminoethoxyethanol, trimethylaminoethylethanolamine, methylhydroxyethylpiperazine, and hydroxyethylmorpholine, etheramines such as bis(dimethylaminoethyl) ether and ethylene glycol bis(dimethyl)aminopropyl ether, and organometallic compounds such as stannous octanoate, dibutyltin diacetate, dibutyltin dilaurate, tin dibutyl mercaptide, dibutyltin thiocarboxylate, dibutyltin dimaleate, dioctyltin mercaptide, dioctyltin thiocarboxylate, phenylmercuric propionate, or lead octenoate. These catalysts may be used alone or in combination of two or more kinds thereof.

Examples of the foaming agent include water, a polydimethylsiloxane-polyethylene oxide copolymer, a polydimethylsiloxane-polypropylene oxide copolymer, and a polydimethylsiloxane-polyethylene adipate copolymer.

As the silicone foam stabilizer, a dimethylpolysiloxane-polyoxyalkylene copolymer or the like is suitably used, and a foam stabilizer formed of a dimethylpolysiloxane moiety having a molecular weight of 350 to 15,000 and a polyoxyalkylene moiety having a molecular weight of 200 to 4,000 is particularly suitably used. The molecular structure of the polyoxyalkylene moiety can be an addition polymer of ethylene oxide or an addition copolymer (referred to as a copolymer obtained by coaddition polymerization) of ethylene oxide and propylene oxide, and the molecular terminal thereof can be ethylene oxide.

Examples of the surfactant include ionic surfactants such as cationic surfactants, anionic surfactants, and amphoteric surfactants, and nonionic surfactants such as various polyethers and various polyesters.

The foam stabilizer and the surfactant may be used alone or in combination of two or more kinds thereof. The amount of the silicone foam stabilizer and various surfactants to be blended can be set to 0.1 to 10 parts by mass or 0.5 to 5 parts by mass with respect to 100 parts by mass of the total amount of the polyisocyanate and the polyol.

In a case where the polyurethane contained in the elastic layer is foamed polyurethane (polyurethane foam), a method which has been used in the related art, such as a mechanical froth method, a water foaming method, or a foaming agent froth method, can be used as a method of foaming the polyurethane foam raw material. Among these, a mechanical froth method of performing mechanical stirring for foaming while mixing an inert gas in is particularly suitable.

From the viewpoint of obtaining a high-quality image in a case of application to the electrophotographic apparatus, the volume resistivity of the elastic layer can be set to 10⁴Ω or greater, 10^{4.5}Ω or greater, 10⁵Ω or greater, 10⁶Ω or greater, or 10⁷Ω or greater, and 10¹⁰Ω or less, 10^{9.5}Ω or less, 10⁹Ω or less, 10^{8.5}Ω or less, or 10⁸Ω or less.

The volume resistivity of the elastic layer can be obtained, for example, by placing a measuring roller on a metal plate, applying a load of 500 g to both ends of the roller, applying a voltage of 100 V between a shaft 12 and the metal plate, and measuring the resistance 5 seconds after the application using a resistance measuring device (R8340, manufactured by Advantest Corporation).

The layer thickness of the elastic layer also depends on the radius of the developing roller, and in a case where the developing roller has, for example, a radius of 5 to 20 mm, the layer thickness of the elastic layer can be set to 2 to 15 mm, 2 to 10 mm, or 3 to 8 mm.

The elastic layer can have an Asker C hardness of 40° to 80°, 45° to 70°, or 50° to 60°. The Asker C hardness is a value measured in conformity with JIS K 7312:1996. When the Asker C hardness is in the above-described ranges, for example, in a case where the conductive roller is a developing roller, the above-described hardness ranges are considered to be optimum for the roller and the photosensitive member to be in contact with each other so that deterioration of the toner is suppressed, the toner lump is broken up, uneven development can be eliminated, and thus an image with a higher image quality can be obtained.

In a case where the polyurethane foamed body is used as the elastic layer, the isocyanate component, the polyol component, the conductive agent, and as necessary, additives are mixed with the polyurethane foamed body. For example, such an elastic layer can be obtained by mechanically stirring and foaming the polyurethane foamed body, cast-molding the polyurethane foamed body in a die where a shaft (metal core) is set, thermally curing the polyurethane foamed body, and forming an elastic layer formed of the polyurethane foamed body around the shaft.

As the UV-curable resin material serving as the elastic layer, for example, a UV-curable resin material described in Japanese Patent Laid-Open No. 2012-159736 can be used.

As the elastic layer, a UV-curable resin material, for example, a UV-curable resin material described in Japanese Patent Laid-Open No. 2012-159736 can be used.

The UV-curable resin material can be obtained, for example, by irradiating a urethane (meth)acrylate oligomer (A), a (meth)acrylate monomer (B), an ionic conductive agent (C), and a photopolymerization initiator (D) with UV light. While a shaft member (a shaft or a metal core) is fixed and rotates, a UV-curable elastic layer can be formed around the shaft member using a die coating method, a curtain coating method, a comma coating method, a spray coating method, or the like.

### Surface Layer

The developing roller 21 of the present disclosure can include a surface layer 24 formed directly or indirectly on the outer periphery of the elastic layer 23. An adhesive layer or an intermediate layer may be provided between the elastic layer 23 and the surface layer 24, and the surface layer 24 can be formed directly on the surface of the elastic layer 23. This surface layer 24 corresponds to a layer that comes into contact with the surface of the photosensitive member in the electrophotographic apparatus.

The surface layer can be formed of various solvent-based coating materials, such as a urethane-based material, an acrylic material, an acrylic urethane-based material, and a fluorine-based material. Among these, the surface layer can contain polyurethane as the resin component. Further, the surface layer can contain at least one selected from the group consisting of urethane resin fine particles, acrylic resin fine particles, fluorine resin fine particles, silicone resin fine particles, and silica fine particles. When the surface layer contains the above-described fine particles, the surface roughness can be adjusted.

A conductive agent (an electronic conductive agent such as carbon black, or an ionic conductive agent), a vulcanizing agent, a vulcanization accelerator, an anti-aging agent, or the like may be appropriately added to the surface layer. Among these, the surface layer can contain a conductive agent in order to further enhance the conductivity of the surface layer. In this manner, an image with a higher image quality can be obtained. At least one selected from ionic conductive agents and electronic conductive agents may be used, or two or more kinds thereof may be used in combination as the conductive agent. Examples of the ionic conductive agent include the ionic conductive agents described in the section of the elastic layer. Further, examples of the electronic conductive agent include fine particles of metal oxides such as ITO, tin oxide, titanium oxide, and zinc oxide, fine particles of metals such as nickel, copper, silver, and germanium, and developed whiskers such as developed titanium oxide whiskers and developed barium titanate whiskers. Further, examples of the electronic conductive agent include developed carbon such as ketjen black or acetylene black, carbon black for rubber such as SAF, ISAF, HAF, FEF, GPF, SRF, FT, or MT, carbon black for coloring, which has been subjected to an oxidation treatment or the like, pyrolytic carbon black, natural graphite, and artificial graphite.

The surface layer can be formed by coating the elastic layer with a predetermined solvent-based coating material using a known method such as dip coating, spray coating, or roll coater coating, drying the coating material, and heating and curing the coating material as desired.

In a case where the surface layer contains polyurethane, a composition for a surface layer, which is used for forming a surface layer, can contain a polyisocyanate and a polyol and can also contain the above-described conductive agent, an anti-aging agent, and the like in addition to the polyisocyanate and the polyol. Further, the composition can further contain a catalyst to promote the reaction between the polyisocyanate and the polyol, and examples of the catalyst include the urethanized catalysts described in the section of the elastic layer.

Examples of the polyisocyanate and the polyol include the compounds described in the section of the elastic layer. In a case where the surface layer contains polyurethane, the polyurethane can be in the form of rubber instead of a foam.

The layer thickness of the elastic layer also depends on the radius of the developing roller, and in a case where the developing roller has, for example, a radius of 3 to 10 mm, the layer thickness of the surface layer can be set to 1 to 50 μm, 2 to 30 μm, or 10 to 30 μm.

From the viewpoint of obtaining a high-quality image in a case of application to the electrophotographic apparatus, the volume resistivity of the surface layer can be set to 10⁵Ω or greater, 10^{5.5}Ω or greater, 10⁶Ω or greater, 10⁷Ω or greater, or 10⁸Ω or greater and 10¹¹Ω or less, 10^{10.5}Ω or less, 10¹⁰Ω or less, 10^{9.5}Ω or less, or 10⁹Ω or less.

### Electrophotographic Apparatus

The electrophotographic apparatus of the present disclosure can include the electrophotographic photosensitive member described above, a charging device, an exposure device, and a contact developing device.

The charging device charges the surface of the electrophotographic photosensitive member.

Further, the exposure device irradiates the charged surface of the electrophotographic photosensitive member with light to form an electrostatic latent image on the surface of the electrophotographic photosensitive member.

Hereinafter, the present disclosure will be described in detail based on the embodiment shown in the figure.

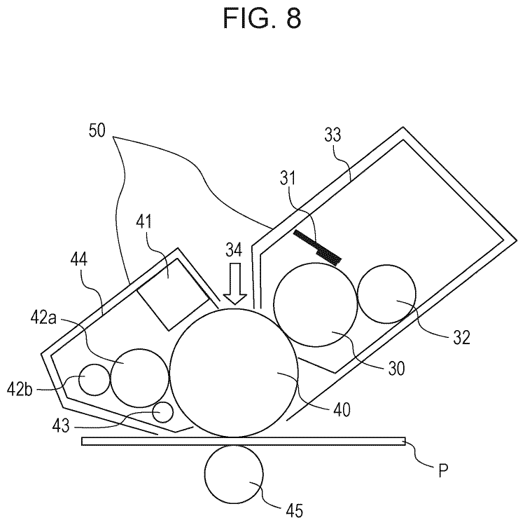

Hereinafter, the electrophotographic apparatus will be described with reference to FIG. 8. FIG. 8 is a cross-sectional view showing an example of the electrophotographic apparatus. An electrophotographic apparatus 100 shown in FIG. 8 includes a contact developing device 33 serving as a contact developing unit, an image carrying member unit 44, an exposure device 34 serving as an exposure unit, and a transfer device 45 serving as a transfer unit. The contact developing device 33 includes a developing roller 30, a toner supplying roller 32, and a layered blade 31. The image carrying member unit 44 includes a photosensitive member 40 (specifically, a single-layer photosensitive member or a laminated-type photosensitive member) serving as an image carrying member, a charging device 41 (specifically, a corona charger) serving as a charging unit, a cleaning member 42a serving as a cleaning member for a photosensitive member, a conductor 42b (specifically, a metal rod), and a pre-exposure device 43 serving as an anti-static unit. Further, a recording medium P is provided at the bottom of the electrophotographic apparatus. The photosensitive member 40 is provided at a center position and the photosensitive member 40 is provided to be rotatable in a clockwise direction in FIG. 8. The charging device 41, the exposure device 34, the contact developing device 33, and the transfer device 45 are provided around the photosensitive member in this order from an upstream side of the photosensitive member in a rotation direction.

The charging device 41 charges the surface (for example, the peripheral surface) of the photosensitive member 40 to a positive polarity. In a case where the photosensitive member 40 is a single-layer photosensitive member, the surface of the photosensitive member 40 is charged to a positive polarity. The charging device 41 is, for example, a corona charger. The exposure device 34 irradiates the charged surface of the photosensitive member 40 with exposure light. That is, the exposure device 34 exposes the charged surface of the photosensitive member 40. In this manner, an electrostatic latent image is formed on the surface of the photosensitive member 40. The electrostatic latent image is formed based on image data that has been input to the electrophotographic apparatus 100. The contact developing device 33 contains a toner and supplies the toner to the surface of the photosensitive member 40 to develop the electrostatic latent image into a toner image. The contact developing device 33 (for example, the surface of the developing roller 30 in the contact developing device 33, more specifically, the peripheral surface of the developing roller 30) is in contact with the surface of the photosensitive member 40. That is, the electrophotographic apparatus 100 employs a developing device of a contact developing system (so-called contact developing device). The contact developing device 33 includes a developing roller. In a case where the developer is a one-component developer, the contact developing device 33 supplies the toner that is the one-component developer to the electrostatic latent image formed on the photosensitive member 40. In a case where the developer is a two-component developer, the contact developing device 33 supplies the toner between the toner and the carrier that are contained in the two-component developer, to the electrostatic latent image formed on the photosensitive member 40. In this manner, the photosensitive member 40 carries the toner image. The transfer device 45 conveys the recording medium P between the photosensitive member 40 and the transfer device 45. The transfer device 45 transfers the toner image developed by the contact developing device 33 from the surface of the photosensitive member 40 to a member to be transferred. The member to be transferred is the recording medium P. When the toner image is transferred, the photosensitive member 40 is in contact with the recording medium P. That is, the electrophotographic apparatus 100 employs a direct transfer system. The transfer device 45 is, for example, a transfer roller. In the recording medium P to which the toner image has been transferred by the transfer device 45, the toner image is fixed by a fixing device (not shown) that is, for example, a heating roller and/or a pressing roller. The unfixed toner image transferred by the transfer device 45 is heated and/or pressed by the fixing device. The toner image is fixed to the recording medium P by being heated and/or pressed. As a result, an image is formed on the recording medium P. Hereinbefore, an example of the electrophotographic apparatus has been described, but the electrophotographic apparatus is not limited to the electrophotographic apparatus 100 described above. The electrophotographic apparatus 100 described above is a monochrome electrophotographic apparatus, but the electrophotographic apparatus may be a color electrophotographic apparatus. In this case, the electrophotographic apparatus may include, for example, a plurality of the contact developing devices 33 and the image carrying member unit 44. Further, the electrophotographic apparatus 100 may employ, for example, a tandem system or a rotary system. The corona charger has been described as an example of the charging device 41, but the charging device may be a charging roller or another non-contact charger (for example, a scorotron charger, a charging brush, or a corotron charger). The electrophotographic apparatus 100 described above employs the contact developing system, but the electrophotographic apparatus may employ a non-contact developing system. The electrophotographic apparatus 100 described above employs the direct transfer system, but the electrophotographic apparatus may employ an intermediate transfer system. In a case where the electrophotographic apparatus employs an intermediate transfer system, the member to be transferred corresponds to an intermediate transfer belt. The electrophotographic apparatus includes a cleaning member in the image carrying member unit 44 described above, and may further include another cleaning member (for example, a cleaning blade). Further, the image carrying member unit 44 described above includes the pre-exposure device, but the pre-exposure device is not necessarily provided.

### Process Cartridge

A process cartridge according to the present disclosure is a process cartridge including an electrophotographic photosensitive member, and a contact developing device having a toner and a developing roller and configured to develop an electrostatic latent image formed on a surface of the electrophotographic photosensitive member by bringing the developing roller carrying the toner into contact with the electrophotographic photosensitive member, in which the process cartridge integrally supports the electrophotographic photosensitive member and the contact developing device, and is detachably attachable to an electrophotographic apparatus main body, in which the electrophotographic photosensitive member includes a surface layer containing a binder resin, the binder resin includes a polyester resin having a structural unit represented by Formula (1) and a structural unit represented by Formula (2), the developing roller includes a shaft member and an elastic layer provided on an outer periphery of the shaft member, and the elastic layer contains urethane rubber.

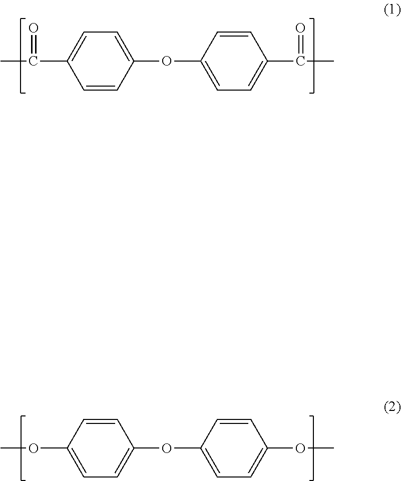

An example of the process cartridge according to the embodiment of the present disclosure will be described still with reference to FIG. 8. The process cartridge corresponds to a combination of the contact developing device 33 and the image carrying member unit 44. The process cartridge includes the photosensitive member 40 and the contact developing device 33. The photosensitive member 40 and the contact developing device 33 are integrally supported by a frame 50 of the process cartridge. The photosensitive member 40 is a photosensitive member of a first embodiment.

The process cartridge can further include the charging device 41 in addition to the photosensitive member 40 and the contact developing device 33. The process cartridge may further include the cleaning member 42a and/or the pre-exposure device 43.

The process cartridge is designed to be detachably attached to the electrophotographic apparatus 100. Therefore, the process cartridge is easy to handle and thus can be easily and quickly replaced along with the photosensitive member 40 in a case where the properties of the photosensitive member 40, such as the sensitivity, are deteriorated. Hereinbefore, the process cartridge including the photosensitive member has been described with reference to FIG. 8.

### EXAMPLES

Hereinafter, the technique of the present disclosure will be described in more detail based on examples and comparative examples. The present disclosure is not limited to the following examples. Further, in the description of the examples below, “parts” is on a mass basis unless otherwise specified.

### Production of Polyester Resin (PAR)

### Synthesis of Resin (PAR-1)

A three-necked flask equipped with a thermometer, a three-way cock, and a dropping funnel was used as a reaction container. The following materials were added to the reaction container.
Compound (BP-2) as monomer (41.0 mmol)
2,6-Dimethylphenol (DMP) as terminal terminator (0.625 mmol)
Sodium hydroxide (98 mmol)
Benzyltributylammonium chloride (0.384 mmol)

The air in the reaction container was replaced with argon gas. Water (300 mL) was added to the contents of the reaction container. The contents of the reaction container were stirred at 50° C. for 1 hour. The contents of the reaction container were cooled to 10° C., thereby obtaining an alkaline aqueous solution A1.

Next, dicarboxylic acid dichloride (32.0 mmol), which is a derivative of a compound (DC-1) that is a monomer, was dissolved in chloroform (150 mL). In this manner, a chloroform solution B1 was obtained.

The chloroform solution B1 was slowly added dropwise to the alkaline aqueous solution A1 over 110 minutes using a dropping funnel. The contents of the reaction container were stirred for 4 hours to promote the polymerization reaction while the temperature (liquid temperature) of the contents of the reaction container was adjusted to 15° C.±5° C. The upper layer (aqueous layer) of the contents of the reaction container was removed by decantation, thereby obtaining an organic layer. Next, deionized water (400 mL) was added to an Erlenmeyer flask. The obtained organic layer was further added to the Erlenmeyer flask. Chloroform (400 mL) and acetic acid (2 mL) were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation, thereby obtaining an organic layer. The obtained organic layer was washed with deionized water (1 L) using a separatory funnel. The organic layer was continuously washed with deionized water five times to obtain an organic layer washed with water. Next, the organic layer washed with water was filtered to obtain a filtrate. The filtrate was slowly added dropwise to methanol (1 L) to obtain a precipitate. The precipitate was taken out by filtration. The precipitate that had been taken out was dried in a vacuum at a temperature of 70° C. for 12 hours. As a result, a resin (PAR-1) having a viscosity average molecular weight of 35,000 was obtained.

### Synthesis of Resin (PAR-52)

A three-necked flask equipped with a thermometer, a three-way cock, and a dropping funnel was used as a reaction container. The following materials were added to the reaction container.
Compound (BP-2) as monomer (28.7 mmol)
Compound (BP-5) as monomer (12.3 mmol)
2,6-Dimethylphenol (DMP) as terminal terminator (0.413 mmol)
Sodium hydroxide (98 mmol)
Benzyltributylammonium chloride (0.384 mmol)

The air in the reaction container was replaced with argon gas. Water (300 mL) was added to the contents of the reaction container. The contents of the reaction container were stirred at 50° C. for 1 hour. The contents of the reaction container were cooled to 10° C., thereby obtaining an alkaline aqueous solution A2.

Next, dicarboxylic acid dichloride (20.8 mmol), which is a derivative of the compound (DC-1) that is a monomer, and dicarboxylic acid dichloride (11.2 mmol), which is a derivative of a compound (DC-4) that is a monomer, were dissolved in chloroform (150 mL). In this manner, a chloroform solution B2 was obtained.

The chloroform solution B2 was slowly added dropwise to the alkaline aqueous solution A2 over 110 minutes using a dropping funnel. The contents of the reaction container were stirred for 4 hours to promote the polymerization reaction while the temperature (liquid temperature) of the contents of the reaction container was adjusted to 15° C.±5° C. The upper layer (aqueous layer) of the contents of the reaction container was removed by decantation, thereby obtaining an organic layer. Next, deionized water (400 mL) was added to an Erlenmeyer flask. The obtained organic layer was further added to the Erlenmeyer flask. Chloroform (400 mL) and acetic acid (2 mL) were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation, thereby obtaining an organic layer. The obtained organic layer was washed with deionized water (1 L) using a separatory funnel. The organic layer was continuously washed with deionized water five times to obtain the organic layer washed with water. Next, the organic layer washed with water was filtered to obtain a filtrate. The filtrate was slowly added dropwise to methanol (1 L) to obtain a precipitate. The precipitate was taken out by filtration. The precipitate that had been taken out was dried in a vacuum at a temperature of 70° C. for 12 hours. As a result, a resin (PAR-52) having a viscosity average molecular weight of 53,600 was obtained.

### Synthesis of Resins (PAR-2) to (PAR-51), (PAR-53) to (PAR-110), and (PAR-201) to (PAR-205)

Each resin (PAR) having the viscosity average molecular weight listed in Table 1 was obtained by performing synthesis using the same method as the method for the synthesis of the resin (PAR-52) having a viscosity average molecular weight of 53,600 except that the proportions of bisphenol and dicarboxylic acid and the kind of the terminal terminator were changed. Further, the viscosity average molecular weight of the resin (PAR) increases as the amount of the terminal terminator to be added decreases.

TABLE 1

| | Dicarboxylic acid | | Bisphenol | | Terminal | Molecular |
|---|---|---|---|---|---|---|
| Resin | DC-1 | DC-4 | BP-2 | BP-5 | terminator | weight |
| PAR-1 | 100 | 0 | 100 | 0 | DMP | 35000 |
| PAR-2 | 100 | 0 | 100 | 0 | DMP | 55000 |
| PAR-3 | 100 | 0 | 100 | 0 | DMP | 66000 |
| PAR-4 | 100 | 0 | 100 | 0 | DMP | 78000 |
| PAR-5 | 100 | 0 | 100 | 0 | DMP | 13000 |
| PAR-6 | 100 | 0 | 100 | 0 | PFH | 66000 |
| PAR-7 | 100 | 0 | 90 | 10 | DMP | 53000 |
| PAR-8 | 100 | 0 | 80 | 20 | DMP | 57000 |
| PAR-9 | 100 | 0 | 70 | 30 | DMP | 66000 |
| PAR-10 | 100 | 0 | 60 | 40 | DMP | 68000 |
| PAR-11 | 100 | 0 | 50 | 50 | DMP | 63000 |
| PAR-12 | 100 | 0 | 30 | 70 | DMP | 58000 |
| PAR-13 | 100 | 0 | 20 | 80 | DMP | 69000 |
| PAR-14 | 100 | 0 | 10 | 90 | DMP | 51000 |
| PAR-15 | 90 | 10 | 100 | 0 | DMP | 61000 |
| PAR-16 | 90 | 10 | 90 | 10 | DMP | 53000 |
| PAR-17 | 90 | 10 | 80 | 20 | DMP | 54000 |
| PAR-18 | 90 | 10 | 70 | 30 | DMP | 67000 |
| PAR-19 | 90 | 10 | 60 | 40 | DMP | 62000 |
| PAR-20 | 90 | 10 | 50 | 50 | DMP | 56000 |
| PAR-21 | 90 | 10 | 40 | 60 | DMP | 59000 |
| PAR-22 | 90 | 10 | 30 | 70 | DMP | 68000 |
| PAR-23 | 90 | 10 | 20 | 80 | DMP | 66900 |
| PAR-24 | 90 | 10 | 10 | 90 | DMP | 51000 |
| PAR-25 | 80 | 20 | 100 | 0 | DMP | 66000 |
| PAR-26 | 80 | 20 | 90 | 10 | DMP | 53000 |
| PAR-27 | 80 | 20 | 80 | 20 | DMP | 57000 |
| PAR-28 | 80 | 20 | 70 | 30 | DMP | 66000 |
| PAR-29 | 80 | 20 | 60 | 40 | DMP | 68000 |
| PAR-30 | 80 | 20 | 50 | 50 | DMP | 58000 |
| PAR-31 | 80 | 20 | 40 | 60 | DMP | 69000 |
| PAR-32 | 80 | 20 | 30 | 70 | DMP | 51000 |
| PAR-33 | 80 | 20 | 20 | 80 | DMP | 61500 |
| PAR-34 | 80 | 20 | 10 | 90 | DMP | 53000 |
| PAR-35 | 70 | 30 | 100 | 0 | DMP | 54700 |
| PAR-36 | 70 | 30 | 90 | 10 | DMP | 67000 |
| PAR-37 | 70 | 30 | 80 | 20 | DMP | 62400 |
| PAR-38 | 70 | 30 | 70 | 30 | DMP | 56000 |
| PAR-39 | 70 | 30 | 60 | 40 | DMP | 59000 |
| PAR-40 | 70 | 30 | 50 | 50 | DMP | 68200 |
| PAR-41 | 70 | 30 | 40 | 60 | DMP | 66000 |
| PAR-42 | 70 | 30 | 30 | 70 | DMP | 52000 |
| PAR-43 | 70 | 30 | 20 | 80 | PFH | 54300 |
| PAR-44 | 70 | 30 | 10 | 90 | DMP | 53000 |
| PAR-45 | 60 | 40 | 100 | 0 | DMP | 57000 |
| PAR-46 | 60 | 40 | 90 | 10 | DMP | 66500 |
| PAR-47 | 60 | 40 | 80 | 20 | DMP | 68000 |
| PAR-48 | 60 | 40 | 70 | 30 | DMP | 58300 |
| PAR-49 | 60 | 40 | 60 | 40 | DMP | 69000 |
| PAR-50 | 60 | 40 | 50 | 50 | DMP | 51000 |
| PAR-51 | 60 | 40 | 40 | 60 | DMP | 61000 |
| PAR-52 | 65 | 35 | 30 | 70 | DMP | 53600 |
| PAR-53 | 60 | 40 | 20 | 80 | DMP | 54000 |
| PAR-54 | 65 | 35 | 20 | 80 | DMP | 52000 |
| PAR-55 | 66 | 34 | 20 | 80 | PFH | 54300 |

TABLE 2

| | Dicarboxylic acid | | Bisphenol | | Terminal | Molecular |
|---|---|---|---|---|---|---|
| Resin | DC-1 | DC-4 | BP-2 | BP-5 | terminator | weight |
| PAR-56 | 60 | 40 | 10 | 90 | DMP | 56000 |
| PAR-57 | 50 | 50 | 100 | 0 | DMP | 59000 |
| PAR-58 | 50 | 50 | 90 | 10 | DMP | 68000 |
| PAR-59 | 50 | 50 | 80 | 20 | DMP | 66000 |
| PAR-60 | 50 | 50 | 70 | 30 | DMP | 51000 |
| PAR-61 | 50 | 50 | 60 | 40 | DMP | 61000 |
| PAR-62 | 50 | 50 | 50 | 50 | DMP | 53600 |
| PAR-63 | 50 | 50 | 40 | 60 | DMP | 54000 |
| PAR-64 | 50 | 50 | 30 | 70 | DMP | 52000 |
| PAR-65 | 50 | 50 | 20 | 80 | PFH | 54300 |
| PAR-66 | 50 | 50 | 10 | 90 | DMP | 56000 |
| PAR-67 | 50 | 50 | 65 | 35 | DMP | 52000 |
| PAR-68 | 50 | 50 | 50 | 50 | PFH | 54300 |
| PAR-69 | 50 | 50 | 55 | 45 | DMP | 51000 |
| PAR-70 | 40 | 60 | 100 | 0 | DMP | 54700 |
| PAR-71 | 40 | 60 | 90 | 10 | DMP | 67000 |
| PAR-72 | 40 | 60 | 80 | 20 | DMP | 62400 |
| PAR-73 | 40 | 60 | 70 | 30 | DMP | 56000 |
| PAR-74 | 40 | 60 | 60 | 40 | DMP | 59000 |
| PAR-75 | 40 | 60 | 50 | 50 | DMP | 57800 |
| PAR-76 | 40 | 60 | 40 | 60 | DMP | 68200 |
| PAR-77 | 40 | 60 | 30 | 70 | DMP | 66000 |
| PAR-78 | 40 | 60 | 20 | 80 | DMP | 52000 |
| PAR-79 | 40 | 60 | 10 | 90 | PFH | 54300 |
| PAR-80 | 30 | 70 | 100 | 0 | DMP | 53000 |
| PAR-81 | 30 | 70 | 90 | 10 | DMP | 57000 |
| PAR-82 | 30 | 70 | 80 | 20 | DMP | 66500 |
| PAR-83 | 30 | 70 | 70 | 30 | DMP | 68000 |
| PAR-84 | 30 | 70 | 60 | 40 | DMP | 58300 |
| PAR-85 | 30 | 70 | 50 | 50 | DMP | 69000 |
| PAR-86 | 30 | 70 | 40 | 60 | DMP | 51000 |
| PAR-87 | 30 | 70 | 30 | 70 | DMP | 61000 |
| PAR-88 | 30 | 70 | 20 | 80 | DMP | 53600 |
| PAR-89 | 30 | 70 | 10 | 90 | DMP | 54000 |
| PAR-90 | 20 | 80 | 100 | 0 | DMP | 54700 |
| PAR-91 | 20 | 80 | 90 | 10 | DMP | 67000 |
| PAR-92 | 20 | 80 | 80 | 20 | DMP | 62400 |
| PAR-93 | 20 | 80 | 70 | 30 | DMP | 56000 |
| PAR-94 | 20 | 80 | 65 | 35 | DMP | 59000 |
| PAR-95 | 20 | 80 | 50 | 50 | DMP | 68200 |
| PAR-96 | 20 | 80 | 45 | 55 | DMP | 66000 |
| PAR-97 | 20 | 80 | 35 | 65 | DMP | 52000 |
| PAR-98 | 20 | 80 | 20 | 80 | PFH | 54300 |
| PAR-99 | 20 | 80 | 10 | 90 | DMP | 52000 |
| PAR-100 | 10 | 90 | 100 | 0 | DMP | 54700 |
| PAR-101 | 10 | 90 | 90 | 10 | DMP | 67000 |
| PAR-102 | 10 | 90 | 80 | 20 | DMP | 62400 |
| PAR-103 | 10 | 90 | 70 | 30 | DMP | 56000 |
| PAR-104 | 10 | 90 | 60 | 40 | DMP | 59000 |
| PAR-105 | 10 | 90 | 50 | 50 | DMP | 59700 |
| PAR-106 | 10 | 90 | 40 | 60 | DMP | 68200 |
| PAR-107 | 10 | 90 | 30 | 70 | DMP | 66000 |
| PAR-108 | 10 | 90 | 20 | 80 | DMP | 52000 |
| PAR-109 | 10 | 90 | 10 | 90 | PFH | 54300 |
| PAR-110 | 10 | 90 | 10 | 90 | DMP | 52000 |

TABLE 3

| | Dicarboxylic acid | | Bisphenol | | Terminal | Molecular |
|---|---|---|---|---|---|---|
| Resin | DC-1 | DC-4 | BP-2 | BP-5 | terminator | weight |
| PAR-201 | 0 | 100 | 50 | 50 | DMP | 55000 |
| PAR-202 | 50 | 50 | 0 | 100 | DMP | 60000 |
| PAR-203 | 0 | 100 | 0 | 100 | DMP | 68000 |

The numerical values in the columns of bisphenol in Tables 1, 2, and 3 denote the ratios of the substance amount of each bisphenol to the total substance amount of two kinds of bisphenols in resins (PAR-1) to (PAR-110) and resins (PAR-201) to (PAR-203). Further, the numerical values in the columns of dicarboxylic acid denote the ratios of the substance amount of each dicarboxylic acid to the total substance amount of two kinds of dicarboxylic acids. Further, PFH denotes 1H,1H-perfluoro-1-heptanol. Further, the molecular weight denotes the viscosity average molecular weight.

### Production of Electrophotographic Photosensitive Member

### Production of Photosensitive Member 1

The following materials were prepared.
Y-type crystal of titanyl phthalocyanine represented by Formula (CGM-1) serving as charge generating material: 2.0 parts by mass
Hole transporting material (H-11): 70.0 parts by mass
Electron transporting material (E-4): 40.0 parts by mass
Additive (30): 14.0 parts by mass
Polyester resin (PAR-1) serving as binder resin: 100.0 parts by mass
Tetrahydrofuran serving as solvent: 500.0 parts by mass

The above-described materials were mixed for 20 minutes using a rod-shaped ultrasonic oscillator to obtain a dispersion liquid. The dispersion liquid was filtered through a filter having an opening of 5 m, thereby obtaining a coating liquid for a photosensitive layer. A support (drum-shaped conductive support made of aluminum) was coated with the coating liquid for a photosensitive layer using a dip coating method, and the coating liquid was dried with hot air at 120° C. for 50 minutes. In this manner, a photosensitive layer (film thickness of 30 m) was formed on the support, thereby obtaining a photosensitive member 1.

### Analysis of Resin Component of Photosensitive Member 1

The polymer component recovered from the obtained photosensitive member was subjected to ¹H-nuclear magnetic resonance spectrometry in deuterated chloroform to obtain a ¹H-NMR spectrum. The obtained ¹H-NMR spectrum had peaks at 8.22±0.02 ppm, 7.18±0.02 ppm, 7.16±0.02 ppm, 7.10±0.02 ppm, 7.06±0.02 ppm, and 7.04±0.02 ppm. In this manner, the photosensitive member was specified to have a structural unit represented by Formula (1) and a structural unit represented by Formula (2). Further, the ratio between the substance amounts of the structural unit represented by Formula (1) and the structural unit represented by Formula (2) was 1:1 based on the integral ratio of the above-described peaks as listed in the columns of PAR-1 in Table 1.

### Production of Photosensitive Members 2 to 100 and 201 to 203

Each of photosensitive members 2 to 100 and 201 to 203 was produced by the same method as the method for the production of the photosensitive member 1 except that the types of the charge generating material, the additive, the hole transporting material, the electron transporting material, and the binder resin were changed. Table 2 lists the types of the charge generating material, the additive, the hole transporting material, the electron transporting material, and the binder resin used. The mass of each material used is the same as that for the photosensitive member 1. Tables 4, 5, and 6 list production examples for the photosensitive members. In the tables, CGM denotes the charge generating material, HTM denotes the hole transporting material, ETM denotes the electron transporting material, and the compound numbers thereof are also listed.

### Analysis of Resin Component of Photosensitive Member 30

The polymer component recovered from the obtained photosensitive member was subjected to ¹H-nuclear magnetic resonance spectrometry in deuterated chloroform to obtain a ¹H-NMR spectrum. The obtained ¹H-NMR spectrum had peaks at 8.22±0.02 ppm, 7.18±0.02 ppm, 7.16±0.02 ppm, 7.10±0.02 ppm, 7.06±0.02 ppm, 7.04±0.02 ppm, 2.28±0.02 ppm, 2.20±0.02 ppm, 1.59±0.02 ppm, and 1.54±0.02 ppm. In this manner, the photosensitive member was specified to have a structural unit represented by Formula (1), a structural unit represented by Formula (2), a structural unit represented by Formula (4), and a structural unit represented by Formula (5). Further, the ratio between the substance amounts of the structural unit represented by Formula (1), the structural unit represented by Formula (2), the structural unit represented by Formula (4), and the structural unit represented by Formula (5) was as listed in the columns of PAR-30 in Table 1 based on the integral ratio of the above-described peaks.

### Measurement of Vickers Hardness

The Vickers hardness of the photosensitive layer was measured as representative examples for each of the photosensitive members listed in Tables 4, 5, and 6 among the produced photosensitive members. Specifically, the Vickers hardness of the photosensitive layer was measured by the method in conformity with Japanese Industrial Standards (JIS) Z 2244. The Vickers hardness was measured by using a hardness tester (“Micro Vickers Hardness Tester DMH-1 type” MATSUZAWA CO., LTD. (formerly known as MATSUZAWA, INC.)). The Vickers hardness was measured under conditions of a temperature of 23° C., a diamond indenter load (test force) of 10 gf, 5 seconds as the time required to reach the test force, a diamond indenter approach speed of 2 mm/sec, and a test force holding time of 1 sec. The measured Vickers hardness is listed in Tables 4, 5, and 6.

TABLE 4

| Example | PAR resin | CGM | HTM | ETM | Additive | Hardness |
|---|---|---|---|---|---|---|
| Photosensitive member-1 | PAR-1 | CGM-1 | H-11 | E-4 | T-1 | 24.0 |
| Photosensitive member-2 | PAR-2 | CGM-1 | H-11 | E-4 | T-1 | 24.7 |
| Photosensitive member-3 | PAR-3 | CGM-1 | H-11 | E-4 | T-1 | 24.9 |
| Photosensitive member-4 | PAR-4 | CGM-1 | H-11 | E-4 | T-1 | 25.1 |
| Photosensitive member-5 | PAR-5 | CGM-1 | H-11 | E-4 | T-1 | 20.6 |
| Photosensitive member-6 | PAR-6 | CGM-1 | H-11 | E-4 | T-1 | 24.9 |
| Photosensitive member-7 | PAR-7 | CGM-1 | H-11 | E-4 | T-1 | 24.1 |
| Photosensitive member-8 | PAR-8 | CGM-1 | H-11 | E-4 | T-1 | 23.6 |
| Photosensitive member-9 | PAR-9 | CGM-1 | H-11 | E-4 | T-1 | 23.1 |
| Photosensitive member-10 | PAR-10 | CGM-1 | H-11 | E-4 | T-1 | 22.6 |
| Photosensitive member-11 | PAR-11 | CGM-1 | H-11 | E-4 | T-1 | 21.9 |
| Photosensitive member-12 | PAR-12 | CGM-1 | H-11 | E-4 | T-1 | 20.6 |
| Photosensitive member-13 | PAR-13 | CGM-1 | H-11 | E-4 | T-1 | 20.2 |
| Photosensitive member-14 | PAR-14 | CGM-1 | H-11 | E-4 | T-1 | 19.2 |
| Photosensitive member-15 | PAR-3 | CGM-1 | H-11 | E-4 | — | 24.8 |
| Photosensitive member-16 | PAR-3 | CGM-1 | H-11 | E-4 | T-1 | 24.8 |
| Photosensitive member-17 | PAR-3 | CGM-1 | H-11 | E-4 | T-1 | 24.8 |
| Photosensitive member-18 | PAR-3 | CGM-1 | H-11 | E-4 | T-1 | 24.8 |
| Photosensitive member-19 | PAR-3 | CGM-1 | H-11 | E-4 | T-1 | 24.8 |
| Photosensitive member-20 | PAR-3 | CGM-1 | H-11 | E-4 | T-1 | 24.8 |
| Photosensitive member-21 | PAR-3 | CGM-1 | H-1 | E-4 | T-1 | 24.8 |
| Photosensitive member-22 | PAR-3 | CGM-1 | H-5 | E-4 | T-1 | 24.8 |
| Photosensitive member-23 | PAR-3 | CGM-1 | H-8 | E-4 | T-1 | 24.8 |
| Photosensitive member-24 | PAR-3 | CGM-1 | H-10 | E-4 | T-1 | 24.8 |
| Photosensitive member-25 | PAR-3 | CGM-1 | H-11 | E-1 | T-1 | 24.8 |
| Photosensitive member-26 | PAR-3 | CGM-1 | H-11 | E-2 | T-1 | 24.8 |
| Photosensitive member-27 | PAR-3 | CGM-1 | H-11 | E-6 | T-1 | 24.8 |
| Photosensitive member-28 | PAR-3 | CGM-1 | H-11 | E-7 | T-1 | 24.8 |
| Photosensitive member-29 | PAR-3 | CGM-1 | H-11 | E-8 | T-1 | 24.8 |
| Photosensitive member-30 | PAR-17 | CGM-1 | H-11 | E-4 | T-1 | 23.0 |
| Photosensitive member-31 | PAR-20 | CGM-1 | H-11 | E-4 | T-1 | 21.5 |
| Photosensitive member-32 | PAR-23 | CGM-1 | H-11 | E-4 | T-1 | 20.0 |
| Photosensitive member-33 | PAR-26 | CGM-1 | H-11 | E-4 | T-1 | 22.9 |
| Photosensitive member-34 | PAR-29 | CGM-1 | H-11 | E-4 | T-1 | 21.7 |
| Photosensitive member-35 | PAR-32 | CGM-1 | H-11 | E-4 | T-1 | 19.9 |
| Photosensitive member-36 | PAR-35 | CGM-1 | H-11 | E-4 | T-1 | 22.8 |
| Photosensitive member-37 | PAR-39 | CGM-1 | H-11 | E-4 | T-1 | 21.2 |
| Photosensitive member-38 | PAR-44 | CGM-1 | H-11 | E-4 | T-1 | 19.1 |
| Photosensitive member-39 | PAR-45 | CGM-1 | H-11 | E-4 | T-1 | 22.4 |
| Photosensitive member-40 | PAR-46 | CGM-1 | H-11 | E-4 | T-1 | 22.2 |
| Photosensitive member-41 | PAR-47 | CGM-1 | H-11 | E-4 | T-1 | 21.9 |
| Photosensitive member-42 | PAR-48 | CGM-1 | H-11 | E-4 | T-1 | 21.3 |
| Photosensitive member-43 | PAR-49 | CGM-1 | H-11 | E-4 | T-1 | 21.1 |
| Photosensitive member-44 | PAR-50 | CGM-1 | H-11 | E-4 | T-1 | 20.4 |
| Photosensitive member-45 | PAR-51 | CGM-1 | H-11 | E-4 | T-1 | 20.3 |
| Photosensitive member-46 | PAR-52 | CGM-1 | H-11 | E-4 | T-1 | 19.9 |
| Photosensitive member-47 | PAR-53 | CGM-1 | H-11 | E-4 | T-1 | 19.4 |
| Photosensitive member-48 | PAR-54 | CGM-1 | H-11 | E-4 | T-1 | 19.4 |
| Photosensitive member-49 | PAR-55 | CGM-1 | H-11 | E-4 | T-1 | 19.5 |
| Photosensitive member-50 | PAR-56 | CGM-1 | H-11 | E-4 | T-1 | 19.1 |

TABLE 5

| | PAR resin | CGM | HTM | ETM | Additive | Hardness |
|---|---|---|---|---|---|---|
| Photosensitive member-51 | PAR-57 | CGM-1 | H-11 | E-4 | T-1 | 21.8 |
| Photosensitive member-52 | PAR-58 | CGM-1 | H-11 | E-4 | T-1 | 21.7 |
| Photosensitive member-53 | PAR-59 | CGM-1 | H-11 | E-4 | T-1 | 21.3 |
| Photosensitive member-54 | PAR-60 | CGM-1 | H-11 | E-4 | T-1 | 20.7 |
| Photosensitive member-55 | PAR-61 | CGM-1 | H-11 | E-4 | T-1 | 20.7 |
| Photosensitive member-56 | PAR-62 | CGM-1 | H-11 | E-4 | T-1 | 20.2 |
| Photosensitive member-57 | PAR-63 | CGM-1 | H-11 | E-4 | T-1 | 19.9 |
| Photosensitive member-58 | PAR-64 | CGM-1 | H-11 | E-4 | T-1 | 19.6 |
| Photosensitive member-59 | PAR-65 | CGM-1 | H-11 | E-4 | T-1 | 19.3 |
| Photosensitive member-60 | PAR-66 | CGM-1 | H-11 | E-4 | T-1 | 19.1 |
| Photosensitive member-61 | PAR-67 | CGM-1 | H-11 | E-4 | T-1 | 20.6 |
| Photosensitive member-62 | PAR-68 | CGM-1 | H-11 | E-4 | T-1 | 20.2 |
| Photosensitive member-63 | PAR-69 | CGM-1 | H-11 | E-4 | T-1 | 20.3 |
| Photosensitive member-64 | PAR-71 | CGM-1 | H-11 | E-4 | T-1 | 21.1 |
| Photosensitive member-65 | PAR-75 | CGM-1 | H-11 | E-4 | T-1 | 20.0 |
| Photosensitive member-66 | PAR-79 | CGM-1 | H-11 | E-4 | T-1 | 19.0 |
| Photosensitive member-67 | PAR-82 | CGM-1 | H-11 | E-4 | T-1 | 20.4 |
| Photosensitive member-68 | PAR-85 | CGM-1 | H-11 | E-4 | T-1 | 19.9 |
| Photosensitive member-69 | PAR-89 | CGM-1 | H-11 | E-4 | T-1 | 19.4 |
| Photosensitive member-70 | PAR-91 | CGM-1 | H-11 | E-4 | T-1 | 20.0 |
| Photosensitive member-71 | PAR-95 | CGM-1 | H-11 | E-4 | T-1 | 19.6 |
| Photosensitive member-72 | PAR-98 | CGM-1 | H-11 | E-4 | T-1 | 19.0 |
| Photosensitive member-73 | PAR-100 | CGM-1 | H-11 | E-4 | T-1 | 19.3 |
| Photosensitive member-74 | PAR-103 | CGM-1 | H-11 | E-4 | T-1 | 19.2 |
| Photosensitive member-75 | PAR-101 | CGM-1 | H-11 | E-4 | T-1 | 19.5 |
| Photosensitive member-76 | PAR-102 | CGM-1 | H-11 | E-4 | T-1 | 19.4 |
| Photosensitive member-77 | PAR-105 | CGM-1 | H-11 | E-4 | T-1 | 19.1 |
| Photosensitive member-78 | PAR-104 | CGM-1 | H-11 | E-4 | T-1 | 19.2 |
| Photosensitive member-79 | PAR-109 | CGM-1 | H-11 | E-4 | T-1 | 18.8 |
| Photosensitive member-80 | PAR-110 | CGM-1 | H-11 | E-4 | T-1 | 18.7 |
| Photosensitive member-81 | PAR-55 | CGM-1 | H-1 | E-4 | T-1 | 19.5 |
| Photosensitive member-82 | PAR-55 | CGM-1 | H-5 | E-4 | T-1 | 19.5 |
| Photosensitive member-83 | PAR-55 | CGM-1 | H-8 | E-4 | T-1 | 19.5 |
| Photosensitive member-84 | PAR-55 | CGM-1 | H-10 | E-4 | T-1 | 19.5 |
| Photosensitive member-85 | PAR-55 | CGM-1 | H-11 | E-1 | T-1 | 19.5 |
| Photosensitive member-86 | PAR-55 | CGM-1 | H-11 | E-2 | T-1 | 19.5 |
| Photosensitive member-87 | PAR-55 | CGM-1 | H-11 | E-6 | T-1 | 19.5 |
| Photosensitive member-88 | PAR-55 | CGM-1 | H-11 | E-7 | T-1 | 19.5 |
| Photosensitive member-89 | PAR-55 | CGM-1 | H-11 | E-8 | T-1 | 19.5 |
| Photosensitive member-90 | PAR-67 | CGM-1 | H-1 | E-4 | T-1 | 20.6 |
| Photosensitive member-91 | PAR-67 | CGM-1 | H-5 | E-4 | T-1 | 20.6 |
| Photosensitive member-92 | PAR-67 | CGM-1 | H-8 | E-4 | T-1 | 20.6 |
| Photosensitive member-93 | PAR-67 | CGM-1 | H-10 | E-4 | T-1 | 20.6 |
| Photosensitive member-94 | PAR-67 | CGM-1 | H-11 | E-1 | T-1 | 20.6 |
| Photosensitive member-95 | PAR-67 | CGM-1 | H-11 | E-2 | T-1 | 20.6 |
| Photosensitive member-96 | PAR-67 | CGM-1 | H-11 | E-6 | T-1 | 20.6 |
| Photosensitive member-97 | PAR-67 | CGM-1 | H-11 | E-7 | T-1 | 20.6 |
| Photosensitive member-98 | PAR-67 | CGM-1 | H-11 | E-8 | T-1 | 20.6 |
| Photosensitive member-99 | PAR-68 | CGM-1 | H-11 | E-4 | — | 19.9 |
| Photosensitive member-100 | PAR-69 | CGM-1 | H-11 | E-4 | — | 19.4 |

TABLE 6

| | PAR resin | CGM | HTM | ETM | Additive | Hardness |
|---|---|---|---|---|---|---|
| Photosensitive member- | PAR-201 | CGM-1 | H-11 | E-4 | T-1 | 13.7 |
| 201 | | | | | | |
| Photosensitive member- | PAR-202 | CGM-1 | H-11 | E-4 | T-1 | 13.8 |
| 202 | | | | | | |
| Photosensitive member- | PAR-203 | CGM-1 | H-11 | E-4 | T-1 | 14.0 |
| 203 | | | | | | |

### Production of Developing Roller

Developing rollers 1 to 4 were obtained by the following methods.

### Production of Developing Roller 1

### Production of Elastic Layer

An isocyanate component obtained by blending 100 parts by mass of a prepolymerized tolylene diisocyanate (TDI) (800BP, manufactured by AGC Inc.) and 25 parts by mass of conductive carbon black (SB805, manufactured by ASAHI CARBON CO., LTD.) was mixed with a polyol component obtained by blending 12.5 parts by mass of an ester-based polyol (F510, manufactured by KURARAY CO., LTD., compound of trifunctional alcohol and adipic acid, molecular weight of 500), 12.5 parts by mass of an ester-based polyol (F1010, manufactured by KURARAY CO., LTD., compound of trifunctional alcohol and adipic acid, molecular weight of 1,000), 25 parts by mass of an ether-based polyol (FA951, manufactured by Sanyo Chemical Industries, Ltd., polyoxyalkylene polyol), 3 parts by mass of a foam stabilizer (SF2937F, manufactured by Dow Corning Toray), 0.05 parts by mass of a catalyst (U-100, manufactured by NITTO KASEI CO., LTD.), 2 parts by mass of aliphatic quaternary ammonium sulfate (KS-48, manufactured by Kao Corporation), and 0.3 parts by mass of sodium perchlorate (MP-100, manufactured by Showa Chemical Industry Co., Ltd.), and the mixture was foamed by a mechanical froth method and injected to a die where a metal shaft (φ7.5 mm) was set. Thereafter, this mixture was heated and cured at 120° C. for 30 minutes to form an elastic layer having a thickness of 4 mm on the outer periphery of the metal shaft. The Asker C hardness of the obtained elastic layer was 52°, which was measured with an Asker C hardness tester (manufactured by KOBUNSHI KEIKI CO., LTD.).

### Production of Surface Layer

100 parts by mass of polytetramethylene glycol ether polyol (PTG100SN, manufactured by HODOGAYA CHEMICAL CO., LTD., OH value of 112 mgKOH/g) was dispersed with 5 parts by mass of carbon black (MA600, manufactured by Mitsubishi Chemical Corporation, carbon black) and 10 parts by mass of urethane particles (trade name: ART PEARL C800, manufactured by Negami Chemical Industrial Co., Ltd., average particle diameter of 8.8 m) in 350 parts by mass of methyl ethyl ketone (MEK), 40 parts by mass of an isocyanate curing agent (CORONATE Hx, manufactured by Tosoh Corporation, NCO %=21%, hexamethylene diisocyanate-based polyisocyanate compound) was added thereto, and the mixture was stirred for 30 minutes using a stirring motor, thereby preparing a coating material for a surface layer. The shaft member provided with the elastic layer was coated with the coating material for a surface layer using a dipping method, and the coating material was dried at 1050 for 120 minutes, thereby forming a surface layer having a thickness of 20 m.

### Production of Developing Roller 2

### Production of Elastic Layer

An isocyanate component obtained by blending 100 parts by mass of isophorone diisocyanate (IPDI) and 25 parts by mass of conductive carbon black (SB805, manufactured by ASAHI CARBON CO., LTD.) was mixed with a polyol component obtained by blending 50 parts by mass of an ether-based polyol (polypropylene glycol (PPG)), 3 parts by mass of a foam stabilizer (SF2937F, manufactured by Dow Corning Toray), 0.05 parts by mass of a catalyst (U-100, manufactured by NITTO KASEI CO., LTD.), 2 parts by mass of aliphatic quaternary ammonium sulfate (KS-48, manufactured by Kao Corporation), and 0.3 parts by mass of sodium perchlorate (MP-100, manufactured by Showa Chemical Industry Co., Ltd.), and the mixture was foamed by a mechanical froth method and injected to a die where a metal shaft (φ7.5 mm) was set. Thereafter, this mixture was heated and cured at 120° C. for 30 minutes to form an elastic layer having a thickness of 4 mm on the outer periphery of the metal shaft. The Asker C hardness of the obtained elastic layer was 56°, which was measured with an Asker C hardness tester (manufactured by KOBUNSHI KEIKI CO., LTD.).

### Production of Surface Layer

100 parts by mass of a lactone-modified polyol (trade name: PCL220AL, manufactured by Daicel Corporation, OH value of 56), 30 parts by mass of carbon black, 10 parts by mass of urethane particles (trade name: ART PEARL C800, manufactured by Negami Chemical Industrial Co., Ltd., average particle diameter of 8.8 m), and 10 parts by mass of silicone resin particles (trade name: KMP605, manufactured by Shin-Etsu Chemical Co., Ltd.) were dispersed in 480 parts by mass of methyl ethyl ketone (MEK), 33 parts by mass of isophorone diisocyanate (IPDI) (trade name: VESTANAT T1890E, manufactured by Degussa-Huls AG, NCO %=12%) and 15% by mass of hexamethylene diisocyanate (HMDI) (trade name: CORONATE Hx, manufactured by Nippon Polyurethane Industry Co., Ltd., NCO %=21%) were added thereto, and the mixture was stirred for 30 minutes using a stirring motor, thereby preparing a coating material for a surface layer. The shaft member provided with the elastic layer was coated with the coating material for a surface layer using a dipping method, and the coating material was dried at 1050 for 120 minutes, thereby forming a surface layer having a thickness of 20 μm.

### Production of Developing Roller 3

### Production of Elastic Layer

An isocyanate component obtained by blending 100 parts by mass of tolylene diisocyanate (TDI) and 25 parts by mass of conductive carbon black (SB805, manufactured by ASAHI CARBON CO., LTD.) was mixed with a polyol component obtained by blending 50 parts by mass of an ether-based polyol (polypropylene glycol (PPG)), 3 parts by mass of a foam stabilizer (SF2937F, manufactured by Dow Corning Toray), 0.05 parts by mass of a catalyst (U-100, manufactured by NITTO KASEI CO., LTD.), 2 parts by mass of aliphatic quaternary ammonium sulfate (KS-48, manufactured by Kao Corporation), and 0.3 parts by mass of sodium perchlorate (MP-100, manufactured by Showa Chemical Industry Co., Ltd.), and the mixture was foamed by a mechanical froth method and injected to a die where a metal shaft (φ7.5 mm) was set. Thereafter, this mixture was heated and cured at 120° C. for 30 minutes to form an elastic layer having a thickness of 4 mm on the outer periphery of the metal shaft. The Asker C hardness of the obtained elastic layer was 60°, which was measured with an Asker C hardness tester (manufactured by KOBUNSHI KEIKI CO., LTD.).

### Production of Surface Layer

100 parts by mass of a lactone-modified polyol (trade name: PCL220AL, manufactured by Daicel Corporation, OH value of 56), 30 parts by mass of carbon black, and 10 parts by mass of urethane particles (trade name: ART PEARL C800, manufactured by Negami Chemical Industrial Co., Ltd., average particle diameter of 8.8 m) were dispersed in 480 parts by mass of methyl ethyl ketone (MEK), 33 parts by mass of isophorone diisocyanate (IPDI) (trade name: VESTANAT T1890E, manufactured by Degussa-Huls AG, NCO %=12%) and 15% by mass of hexamethylene diisocyanate (HMDI) (trade name: CORONATE Hx, manufactured by Nippon Polyurethane Industry Co., Ltd., NCO %=21%) were added thereto, and the mixture was stirred for 30 minutes using a stirring motor, thereby preparing a coating material for a surface layer. The shaft member provided with the elastic layer was coated with the coating material for a surface layer using a dipping method, and the coating material was dried at 1050 for 120 minutes, thereby forming a surface layer having a thickness of 20 m.

### Production of Developing Roller 4

### Production of Elastic Layer

An isocyanate component obtained by blending 100 parts by mass of isophorone diisocyanate (IPDI) and 25 parts by mass of conductive carbon black (SB805, manufactured by ASAHI CARBON CO., LTD.) was mixed with a polyol component obtained by blending 50 parts by mass of an ether-based polyol (polypropylene glycol (PPG)), 3 parts by mass of a foam stabilizer (SF2937F, manufactured by Dow Corning Toray), 0.05 parts by mass of a catalyst (U-100, manufactured by NITTO KASEI CO., LTD.), 2 parts by mass of aliphatic quaternary ammonium sulfate (KS-48, manufactured by Kao Corporation), and 0.3 parts by mass of an ionic conductive agent (lithium salt) (trade name “EF-N115”, manufactured by Mitsubishi Materials Corporation), and the mixture was foamed by a mechanical froth method and injected to a die where a metal shaft (φ7.5 mm) was set. Thereafter, this mixture was heated and cured at 120° C. for 30 minutes to form an elastic layer having a thickness of 4 mm on the outer periphery of the metal shaft. The Asker C hardness of the obtained elastic layer was 56°, which was measured with an Asker C hardness tester (manufactured by KOBUNSHI KEIKI CO., LTD.).

### Production of Surface Layer

100 parts by mass of a lactone-modified polyol (trade name: PCL220AL, manufactured by Daicel Corporation, OH value of 56), 0.5 parts by mass of dioctyltin, and 50 parts by mass of tolylene diisocyanate (TDI) were allowed to react in a propylene glycol 1-monomethyl ether 2-acetate (PMA) solvent while being heated and stirred in a vacuum, and hydroxyethyl acrylate (HEA) was added thereto after the peak intensity of the isocyanate was saturated by infrared spectroscopy (IR), thereby obtaining a urethane acrylate coating material when the peak of the isocyanate disappeared by IR. The mass ratio of the lactone-modified polyol to TDI (lactone-modified polyol/TDI) added was set to 1.95.

A coating material for a surface layer was obtained by blending 100 parts by mass of the urethane acrylate with 35 parts by mass of a surface roughening agent (polytetrafluoroethylene resin particles, trade name “TF9270”, manufactured by 3M Limited) and 2 parts by mass of an ultraviolet curing agent (α-aminoalkylphenone, trade name “Irgacure 907”, manufactured by BASF SE).

Next, a surface layer was coated with the coating material such that the film thickness thereof was set to about 1 m by a roll coating method and irradiated with UV light (intensity of 3,000 mW/cm², time: 10 seconds, 25° C.) in a nitrogen atmosphere, thereby forming a surface layer.

### EXAMPLES

### Evaluation

The image failure (uneven density) of each of the photosensitive member and the developing roller was evaluated by the following method. A modified machine of an electrophotographic apparatus (Monochrome LBP “HL-L6310”, manufactured by Brother Industries, Ltd.) was used as the evaluation machine. A process cartridge for this evaluation machine was provided with a corona charger as a charging device. The charging polarity was a positive polarity. Further, the contact developing device was provided with a developing roller, and had a one-component contact developing system. The developing roller was removed from the developing unit in the process cartridge, and each of the produced developing rollers was set therein. Further, the photosensitive member was removed from the photosensitive member unit in the process cartridge, and the produced photosensitive member was set therein.

### Evaluation of Uneven Density of Image

The process cartridge on which the produced photosensitive member and the produced developing roller were mounted was allowed to stand in an environment of a temperature of 50° C. and a humidity of 95% RH for 1 month. This process cartridge was mounted on an electrophotographic apparatus, and 40,000 sheets were output for endurance in an intermittent mode set such that printing two sheets of images with a printing ratio of 1% under conditions of a temperature of 35° C. and a humidity of 80% RH was set as one job and the apparatus was set to temporarily stop between jobs before the next job began. After the endurance, halftone images and horizontal line pattern images (4-dot horizontal lines were printed at intervals of 176 dot spaces) were output and evaluated. Plain paper CS-680 (68 g/m²) (Canon Marketing Japan Inc.) was used as paper.

### Uneven Density of Halftone Image

The uneven density was evaluated by forming a halftone (20H) image, and the density uniformity of this image was evaluated according to the following criteria. Plain paper CS-680 (68 g/m²) (Canon Marketing Japan Inc.) was used as paper. Further, the 20H image is a halftone image in which 256 gradations are expressed in hexadecimal, and 00H is defined as solid white (non-image) and FFH is defined as solid black (full image). The evaluation was performed according to the following evaluation criteria. The density was measured at 20 sites and determined as follows based on a difference in density between the maximum value and the minimum value (density uniformity). Further, the density was measured with an X-Rite color reflection densitometer (X-rite 500 Series, manufactured by X-rite Inc.).
A: The density uniformity was less than 0.04.
B: The density uniformity was 0.04 or greater and less than 0.06.
C: The density uniformity was 0.06 or greater and less than 0.08.
D: The density uniformity was 0.08 or greater and less than 0.10.
E: The density uniformity was 0.10 or greater.

### Blank Dots of Horizontal Line Pattern Image

Since the image was line-shaped, the line chipping, that is, blank dots were evaluated instead of the uneven density. The output image was observed using a loupe at a magnification of 25 times, and blank dots were evaluated according to the following evaluation criteria.
A: Blank dots did not occur when the image was observed with a loupe at a magnification of 25 times.
B: Blank dots occurred at some sites in the periphery of the image when the image was observed with a loupe at a magnification of 25 times.
C: Blank dots occurred at multiple sites in the periphery of the image when the image was observed with a loupe at a magnification of 25 times.
D: Occurrence of blank dots was confirmed even when visually observed.
E: Occurrence of blank dots was clearly confirmed when visually observed.

The evaluation results thereof are listed in Tables 7 and 8.

TABLE 7

| | Photosensitive | | Uneven | Blank |
|---|---|---|---|---|
| Example | member | Developing roller | density | dot |
| Example-1 | Photosensitive | Developing roller-1 | B | C |
| | member-1 | | | |
| Example-2 | Photosensitive | Developing roller-1 | B | C |
| | member-4 | | | |
| Example-3 | Photosensitive | Developing roller-2 | A | C |
| | member-4 | | | |
| Example-4 | Photosensitive | Developing roller-3 | A | C |
| | member-4 | | | |
| Example-5 | Photosensitive | Developing roller-4 | A | C |
| | member-4 | | | |
| Example-6 | Photosensitive | Developing roller-1 | A | C |
| | member-5 | | | |
| Example-7 | Photosensitive | Developing roller-1 | B | c |
| | member-9 | | | |
| Example-8 | Photosensitive | Developing roller-1 | A | c |
| | member-10 | | | |
| Example-9 | Photosensitive | Developing roller-1 | A | C |
| | member-11 | | | |
| Example-10 | Photosensitive | Developing roller-1 | A | C |
| | member-12 | | | |
| Example-11 | Photosensitive | Developing roller-1 | B | C |
| | member-21 | | | |
| Example-12 | Photosensitive | Developing roller-1 | B | C |
| | member-22 | | | |
| Example-13 | Photosensitive | Developing roller-1 | B | C |
| | member-23 | | | |
| Example-14 | Photosensitive | Developing roller-1 | B | C |
| | member-24 | | | |
| Example-15 | Photosensitive | Developing roller-1 | B | C |
| | member-25 | | | |
| Example-16 | Photosensitive | Developing roller-1 | B | C |
| | member-26 | | | |
| Example-17 | Photosensitive | Developing roller-1 | B | C |
| | member-27 | | | |
| Example-18 | Photosensitive | Developing roller-1 | B | C |
| | member-28 | | | |
| Example-19 | Photosensitive | Developing roller-1 | B | C |
| | member-29 | | | |
| Example-20 | Photosensitive | Developing roller-1 | B | B |
| | member-30 | | | |
| Example-21 | Photosensitive | Developing roller-1 | A | B |
| | member-33 | | | |
| Example-22 | Photosensitive | Developing roller-1 | A | B |
| | member-36 | | | |
| Example-23 | Photosensitive | Developing roller-1 | A | B |
| | member-39 | | | |
| Example-24 | Photosensitive | Developing roller-1 | A | B |
| | member-41 | | | |
| Example-25 | Photosensitive | Developing roller-1 | A | A |
| | member-44 | | | |
| Example-26 | Photosensitive | Developing roller-1 | A | A |
| | member-45 | | | |
| Example-27 | Photosensitive | Developing roller-1 | A | A |
| | member-46 | | | |
| Example-28 | Photosensitive | Developing roller-1 | A | A |
| | member-47 | | | |
| Example-29 | Photosensitive | Developing roller-1 | A | A |
| | member-48 | | | |
| Example-30 | Photosensitive | Developing roller-1 | A | A |
| | member-49 | | | |
| Example-31 | Photosensitive | Developing roller-2 | A | A |
| | member-49 | | | |
| Example-32 | Photosensitive | Developing roller-3 | A | B |
| | member-49 | | | |
| Example-33 | Photosensitive | Developing roller-4 | A | C |
| | member-49 | | | |
| Example-34 | Photosensitive | Developing roller-1 | A | A |
| | member-58 | | | |
| Example-35 | Photosensitive | Developing roller-1 | A | A |
| | member-60 | | | |
| Example-36 | Photosensitive | Developing roller-1 | A | A |
| | member-64 | | | |
| Example-37 | Photosensitive | Developing roller-1 | A | A |
| | member-69 | | | |
| Example-38 | Photosensitive | Developing roller-1 | A | A |
| | member-77 | | | |
| Example-39 | Photosensitive | Developing roller-1 | A | B |
| | member-79 | | | |
| Example-40 | Photosensitive | Developing roller-1 | A | B |
| | member-80 | | | |

TABLE 8

| Comparative | | Developing | Uneven | Blank |
|---|---|---|---|---|
| Example | Photosensitive member | roller | density | dots |
| Comparative | Photosensitive member- | Developing | D | D |
| Example-1 | 201 | roller-1 | | |
| Comparative | Photosensitive member- | Developing | E | E |
| Example-2 | 201 | roller-2 | | |
| Comparative | Photosensitive member- | Developing | E | E |
| Example-3 | 201 | roller-3 | | |
| Comparative | Photosensitive member- | Developing | E | E |
| Example-4 | 201 | roller-4 | | |
| Comparative | Photosensitive member- | Developing | D | D |
| Example-5 | 202 | roller-1 | | |
| Comparative | Photosensitive member- | Developing | E | E |
| Example-6 | 203 | roller-1 | | |

In Examples 1 to 40 in which the photosensitive member containing a polyester resin and the developing roller of the present disclosure were used, image failure (uneven density) was suppressed, and the quality of the output image was maintained even after the endurance.

On the contrary, in the comparative examples, image failure was significant.

According to the present disclosure, it is possible to provide an electrophotographic apparatus including a developing roller that has an elastic layer containing urethane rubber, in which image failure (uneven density) after endurance in a high-temperature and high-humidity environment is suppressed and a high image quality is maintained from the initial stage through to the end of endurance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176792, filed Oct. 8, 2024, which is hereby incorporated by reference herein in its entirety.

What is claimed is:

1. An electrophotographic apparatus comprising:
an electrophotographic photosensitive member; and
a contact developing device having a toner and a developing roller and configured to develop an electrostatic latent image formed on a surface of the electrophotographic photosensitive member by bringing the developing roller carrying the toner into contact with the electrophotographic photosensitive member,
wherein the electrophotographic photosensitive member includes a surface layer containing a binder resin,
the binder resin includes a polyester resin,
the polyester resin has a structural unit represented by Formula (1) and a structural unit represented by Formula (2),
the developing roller has an elastic layer, and
the elastic laver contains urethane rubber,

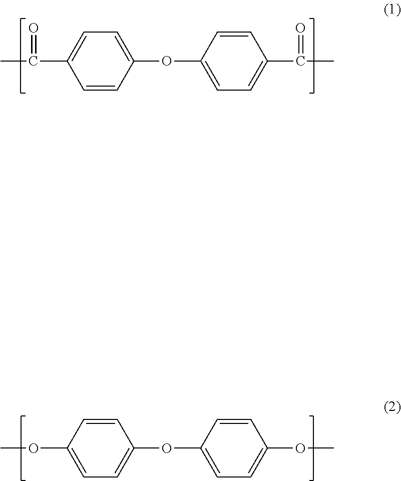

2. The electrophotographic apparatus according to claim 1,
wherein the polyester resin further has a structural unit represented by Formula (4) and a structural unit represented by Formula (5),

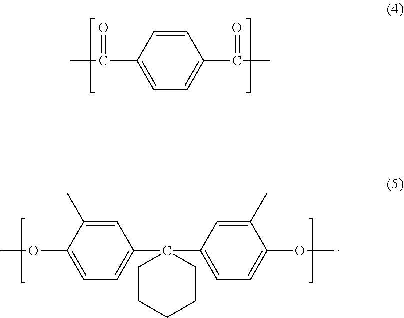

3. The electrophotographic apparatus according to claim 2,
wherein when a substance amount of the structural unit represented by Formula (1) in the polyester resin is defined as M1, and a substance amount of the structural unit represented by Formula (4) in the polyester resin is defined as M4, 0.30≤M4/(M1+M4)≤0.70 is satisfied.

4. The electrophotographic apparatus according to claim 2,
wherein when a substance amount of the structural unit represented by Formula (2) in the polyester resin is defined as M2, and a substance amount of the structural unit represented by Formula (5) in the polyester resin is defined as M5, 0<M2/(M2+M5)≤0.50 is satisfied.

5. The electrophotographic apparatus according to claim 1,
wherein when a total substance amount of a structural unit derived from a dicarboxylic acid constituting the polyester resin is defined as MC, and a substance amount of the structural unit represented by Formula (1) is defined as M1, M1/MC≥0.50 is satisfied.

6. The electrophotographic apparatus according to claim 1,
wherein a proportion of the polyester resin is 50% by mass or greater with respect to a total mass of the binder resin.

7. The electrophotographic apparatus according to claim 1,
wherein the electrophotographic photosensitive member includes a single-layer photosensitive layer containing a charge generating material, a hole transporting material, and an electron transporting material.

8. The electrophotographic apparatus according to claim 7,
wherein the electron transporting material contains at least one selected from the group consisting of a compound represented by Formula (10), a compound represented by Formula (11), a compound represented by Formula (12), a compound represented by Formula (13), a compound represented by Formula (14), a compound represented by Formula (15), and a compound represented by Formula (16), 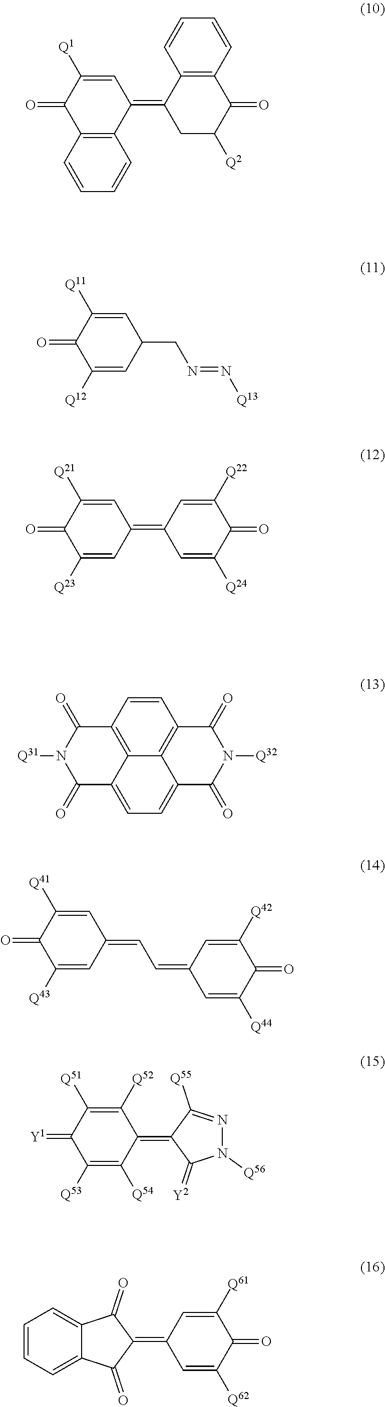
Q¹ and Q² in Formula (10), Q¹¹, Q¹², and Q¹³ in Formula (11), Q²¹, Q²², Q²³, and Q²⁴ in Formula (12), Q³¹ and Q³² in Formula (13), Q⁴¹, Q⁴², Q⁴³, and Q⁴⁴ in Formula (14), Q⁵¹, Q⁵², Q⁵³, Q⁵⁴, Q⁵⁵, and Q⁵⁶ in Formula (15), and Q⁶¹ and Q⁶² in Formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms, which may be substituted with at least one substituent selected from the group consisting of an alkyl group having 1 or more and 6 or less carbon atoms and a halogen atom, and Y¹ and Y² in Formula (15) each independently represent an oxygen atom or a sulfur atom.

9. The electrophotographic apparatus according to claim 7,
wherein the electron transporting material contains at least one selected from the group consisting of a compound represented by Formula (E-1), a compound represented by Formula (E-2), a compound represented by Formula (E-3), a compound represented by Formula (E-4), a compound represented by Formula (E-5), a compound represented by Formula (E-6), a compound represented by Formula (E-7), and a compound represented by Formula (E-8),

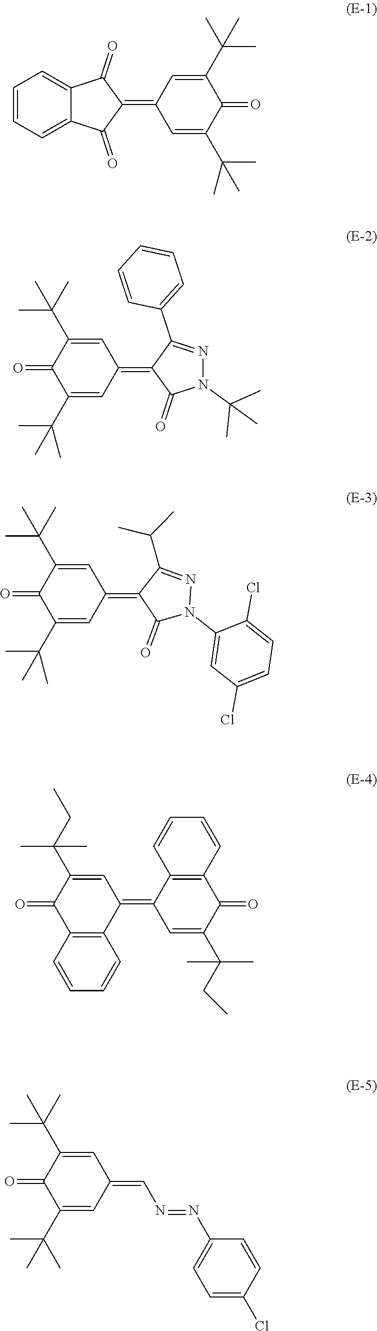

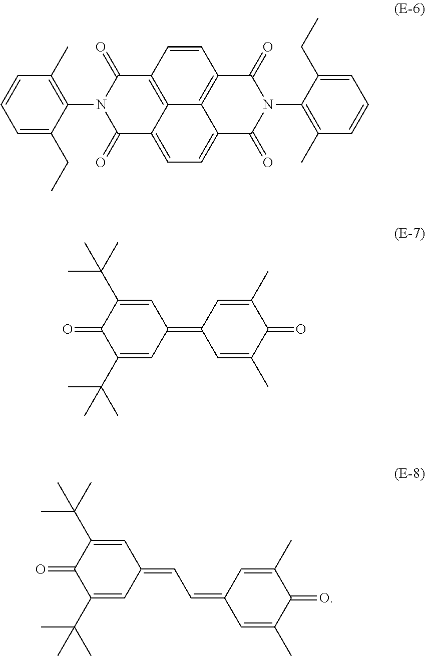 [SMILES: CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

10. The electrophotographic apparatus according to claim 7,
wherein the hole transporting material contains at least one selected from the group consisting of a compound represented by Formula (20), a compound represented by Formula (21), a compound represented by Formula (22), a compound represented by Formula (23), and a compound represented by Formula (24), 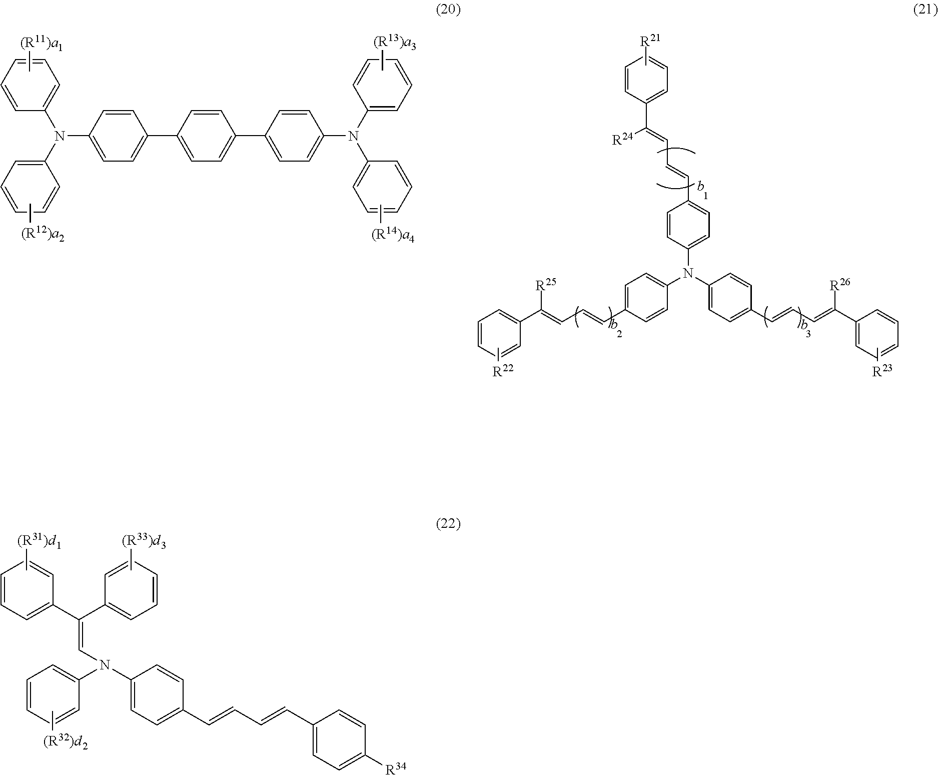 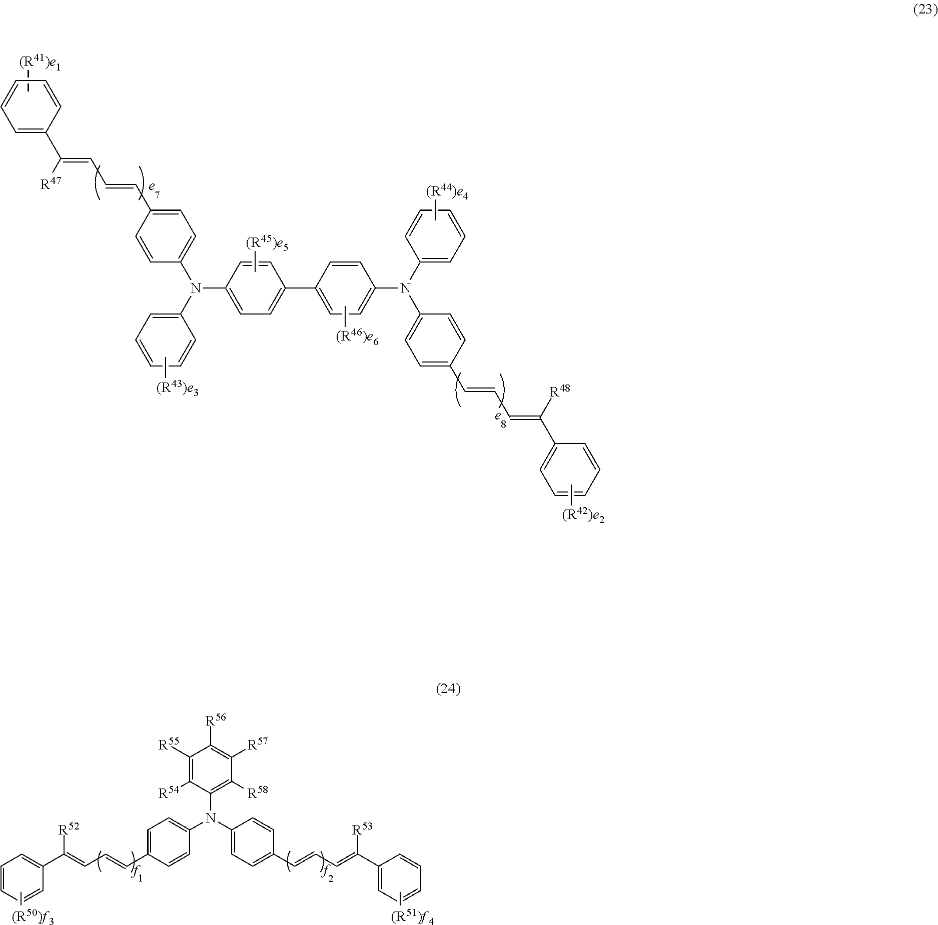
in Formula (20), R¹¹, R¹², R¹³, and R¹⁴ each independently represent an alkyl group having 1 or more and 6 or less carbon atoms or an alkoxy group having 1 or more and 6 or less carbon atoms, a₁, a₂, a₃, and a₄ each independently represent an integer of 0 or greater and 5 or less,
in Formula (21), R²¹, R²², and R²³ each independently represent an alkyl group having 1 or more and 6 or less carbon atoms, R²⁴, R²⁵, and R²⁶ each independently represent a hydrogen atom or an alkyl group having 1 or more and 6 or less carbon atoms, b₁, b₂, and b₃ each independently represent 0 or 1,
in Formula (22), R³¹, R³², and R³³ each independently represent an alkyl group having 1 or more and 6 or less carbon atoms, R³⁴ represents an alkyl group having 1 or more and 6 or less carbon atoms or a hydrogen atom, d₁, d₂, and d₃ each independently represent an integer of 0 or greater and 5 or less.
in Formula (23), R⁴¹, R⁴², R⁴³, R⁴⁴, R⁴⁵, and R⁴⁶ each independently represent an alkyl group having 1 or more and 6 or less carbon atoms or a phenyl group, R⁴⁷ and R⁴⁸ each independently represent a hydrogen atom, an alkyl group having 1 or more and 6 or less carbon atoms, or a phenyl group, e₁, e₂, e₃, and e₄ each independently represent an integer of 0 or greater and 5 or less,
e₅ and e₆ each independently represent an integer of 0 or greater and 4 or less, e₇ and e₈ each independently represent 0 or 1,
in Formula (24), R⁵⁰ and R⁵¹ each independently represent an alkyl group having 1 or more and 6 or less carbon atoms, an alkoxy group having 1 or more and 6 or less carbon atoms, or a phenyl group, R⁵², R⁵³, R⁵⁴, R⁵⁵, R⁵⁶, R⁵⁷, and R⁵¹ each independently represent a hydrogen atom, an alkyl group having 1 or more and 6 or less carbon atoms, an alkoxy group having 1 or more and 6 or less carbon atoms, or a phenyl group which may be substituted with an alkyl group having 1 or more and 6 or less carbon atoms, f₁ and f₂ each independently represent an integer of 0 or greater and 2 or less, and f₃ and f₄ each independently represent an integer of 0 or greater and 5 or less.

11. The electrophotographic apparatus according to claim 7,
wherein the hole transporting material contains at least one selected from the group consisting of a compound represented by Formula (H-1), a compound represented by Formula (H-2), a compound represented by Formula (H-3), a compound represented by Formula (H-4), a compound represented by Formula (H-5), a compound represented by Formula (H-6), a compound represented by Formula (H-7), a compound represented by Formula (H-8), a compound represented by Formula (H-9), a compound represented by Formula (H-10), and a compound represented by Formula (H-11),

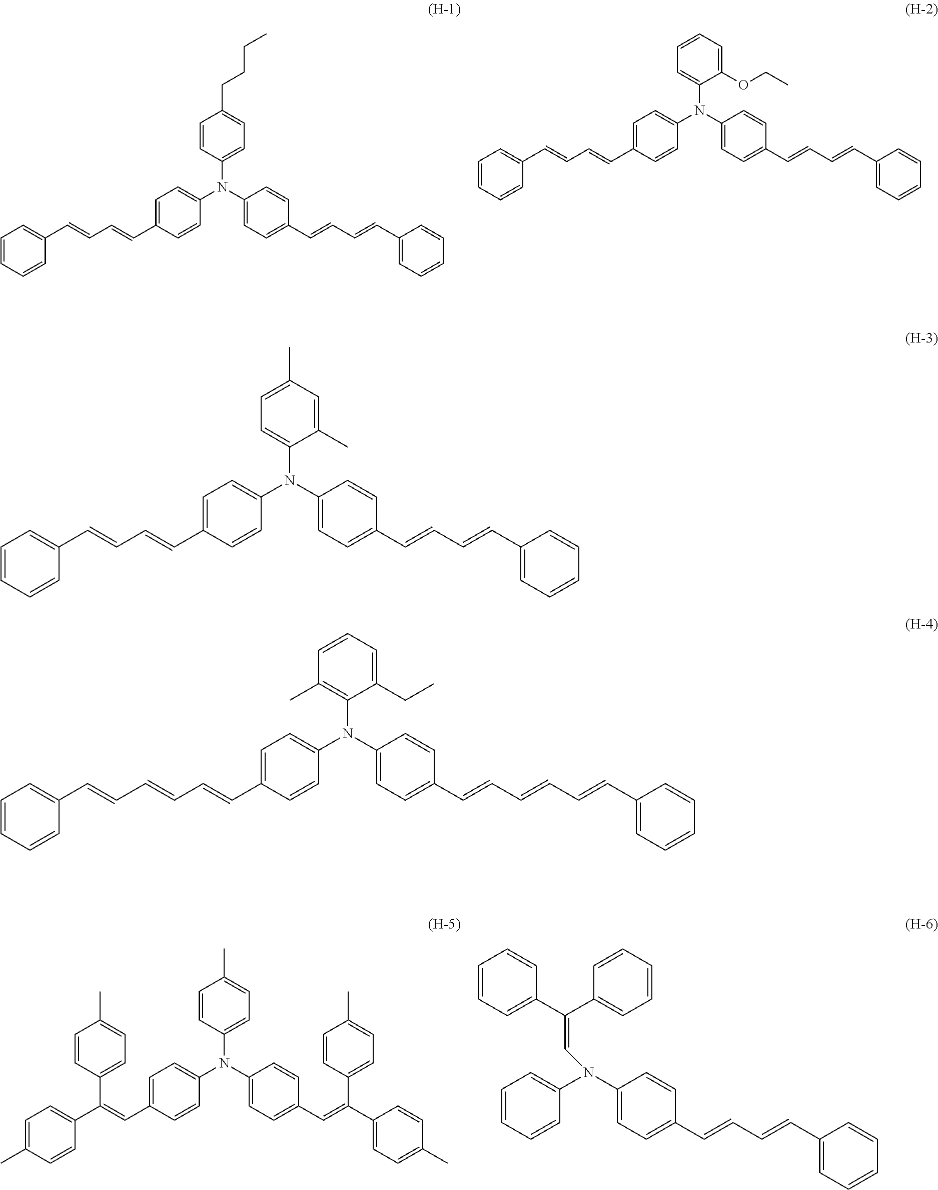

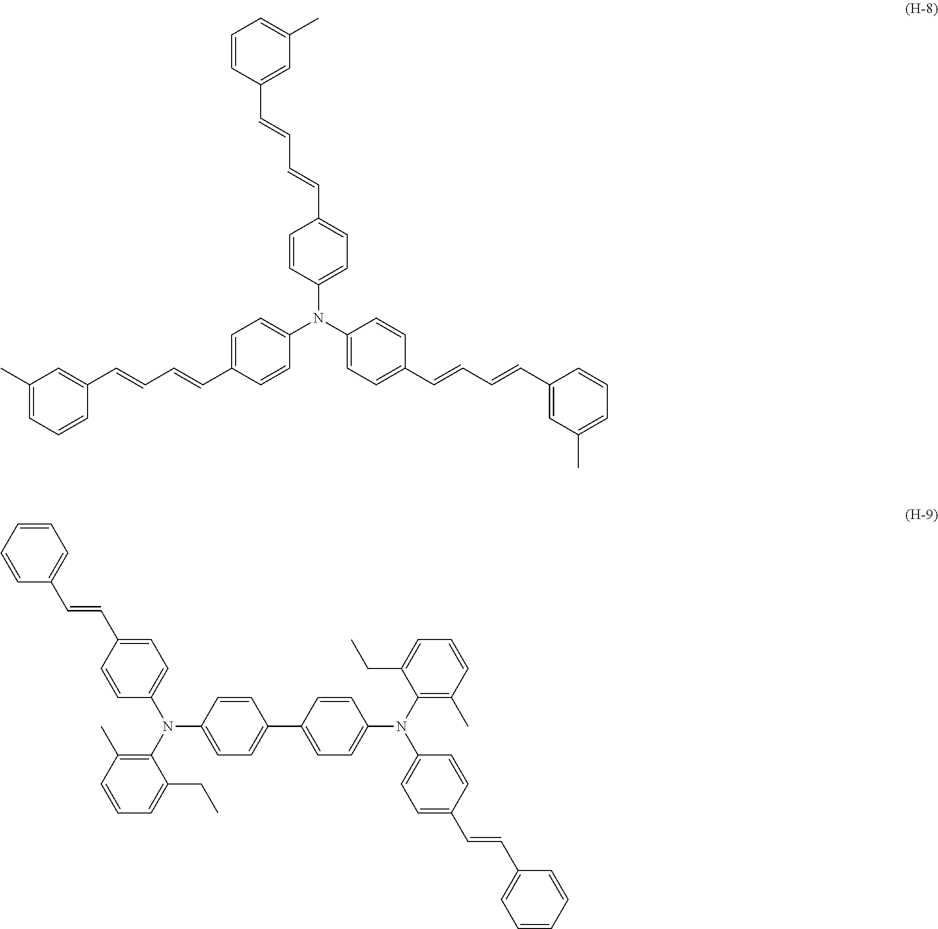 [SMILES: Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1]

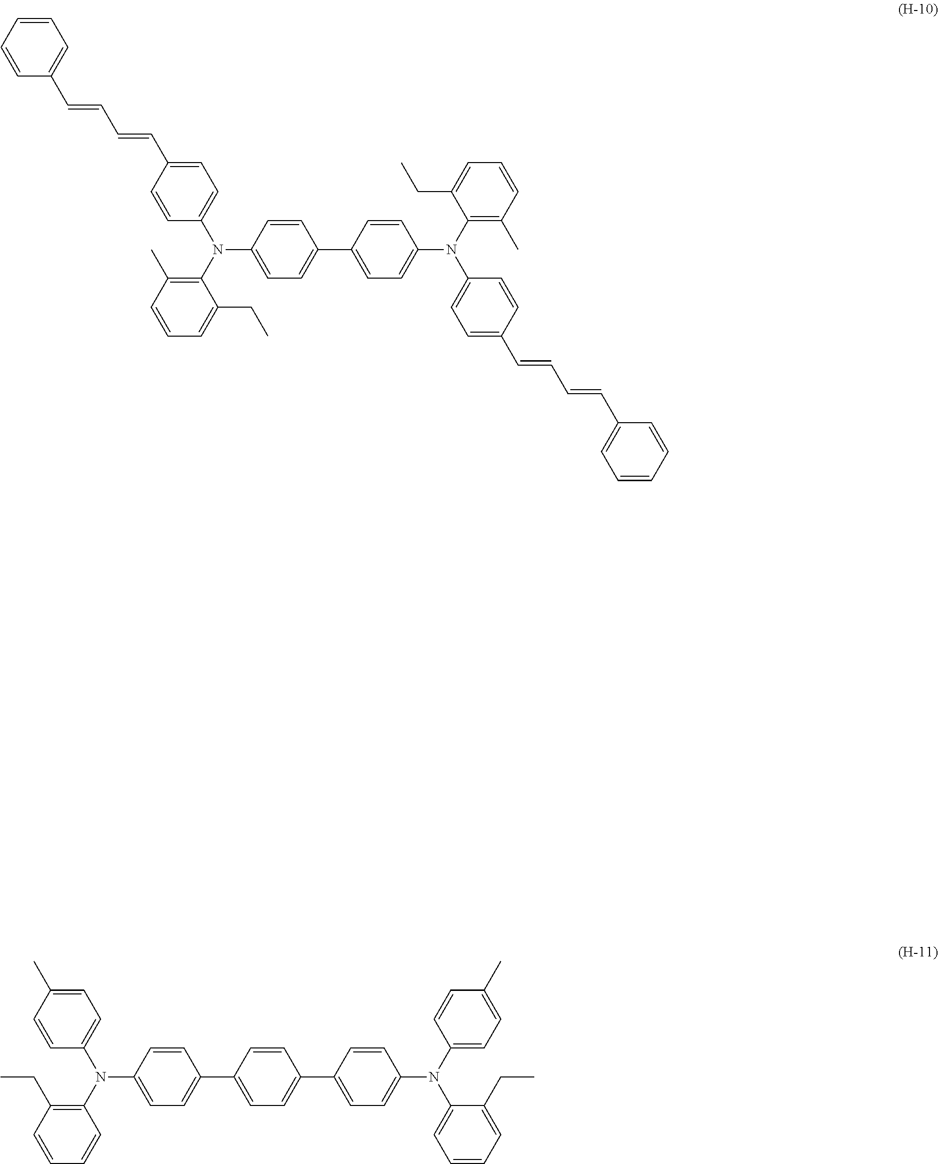 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

12. The electrophotographic apparatus according to claim 7,
wherein the charge generating material contains titanyl phthalocyanine.

13. The electrophotographic apparatus according to claim 7,
wherein the photosensitive layer contains a compound represented by Formula (30),

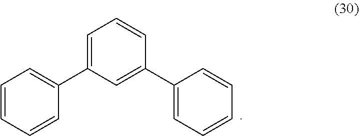 [SMILES: c1ccc(-c2cccc(-c3ccccc3)c2)cc1]

14. The electrophotographic apparatus according to claim 1,
wherein an isocyanate component constituting the urethane rubber contains at least one selected from the group consisting of isophorone diisocyanate and tolylene diisocyanate.

15. The electrophotographic apparatus according to claim 1,
wherein the developing roller includes a surface layer on the elastic layer, and the surface layer contains at least any one selected from the group consisting of urethane resin fine particles, acrylic resin fine particles, fluorine resin fine particles, silicone resin fine particles, and silica fine particles.

16. A process cartridge comprising:
an electrophotographic photosensitive member; and
a contact developing device having a toner and a developing roller and configured to develop an electrostatic latent image formed on a surface of the electrophotographic photosensitive member by bringing the developing roller carrying the toner into contact with the electrophotographic photosensitive member,
wherein the process cartridge integrally supports the electrophotographic photosensitive member and the contact developing device, and is detachably attachable to an electrophotographic apparatus main body,
wherein the electrophotographic photosensitive member includes a surface layer containing a binder resin,
the binder resin includes a polyester resin,
the polyester resin has a structural unit represented by Formula (1) and a structural unit represented by Formula (2),
the developing roller has an elastic layer, and
the elastic layer contains urethane rubber,

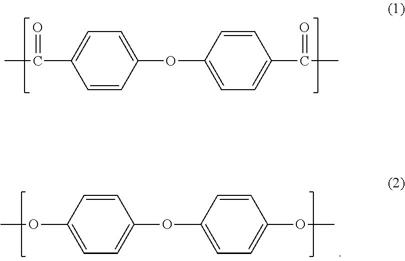

17. The process cartridge according to claim 16,
wherein the process cartridge integrally supports the electrophotographic photosensitive member, the contact developing device, and a charging device for charging the surface of the electrophotographic photosensitive member.
